(19) United States
(12) Patent Application Publication
(10) Pub. No.: US 2021/0195192 A1
(43) Pub. Date: Jun. 24, 2021

(54) COEFFICIENT GROUP BASED RESTRICTION ON MULTIPLE TRANSFORM SELECTION SIGNALING IN VIDEO CODING

(71) Applicant: QUALCOMM Incorporated, San Diego, CA (US)

(72) Inventors: Muhammed Zeyd Coban, Carlsbad, CA (US); Marta Karczewicz, San Diego, CA (US); Hilmi Enes Egilmez, San Diego, CA (US); Vadim Seregin, San Diego, CA (US)

(21) Appl. No.: 17/125,159

(22) Filed: Dec. 17, 2020

Related U.S. Application Data
(60) Provisional application No. 62/951,975, filed on Dec. 20, 2019.

(51) Int. Cl. H04N 19/12; H04N 19/176; H04N 19/18; H04N 19/70; H04N 19/60

(52) U.S. Cl. CPC H04N 19/12; H04N 19/176; H04N 19/60; H04N 19/70; H04N 19/18

(57) ABSTRACT

A video coder may determine, for a transform block of video data, that at least one coefficient group, of the transform block, that comprises a non-zero transform coefficient is outside of a lowest frequency region of the transform block, wherein the at least one coefficient group is one of a plurality of coefficient groups that each comprise transform coefficients. The video coder may determine not to code a syntax element indicative of a multiple transform selection (MTS) for the transform block based at least in part on the determination of that the at least one coefficient group is outside of the lowest frequency region of the transform block. The video coder may code the video data based at least in part on the determination not to code the syntax element indicative of the multiple transform selection for the transform block.

This application claims the benefit of U.S. Provisional Application No. 62/951,975, filed Dec. 20, 2019, which is hereby incorporated by reference in its entirety.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, aspects of the present disclosure are related to transform coding, which is an element of video compression standards. Aspects of the present disclosure describes transform signaling techniques that can be used in a video encoder or decoder (codec) to specify the transform selected among multiple transform candidates for encoding and/or decoding. The techniques described herein may reduce the signaling overhead based on available side information such as intra mode, thereby improving coding efficiency, and can be used in advanced video codecs including extensions of High Efficiency Video Coding (HEVC/H.265) and the next generation of video coding standards such as Versatile Video Coding (VVC/H.266).

In one example, this disclosure describes a method of coding video data includes determining, for a transform block of video data, that at least one coefficient group, of the transform block, that comprises a non-zero transform coefficient is outside of a lowest frequency region of the transform block, wherein the at least one coefficient group is one of a plurality of coefficient groups that each comprise transform coefficients; determining not to code a syntax element indicative of a multiple transform selection (MTS) for the transform block based at least in part on the determination of that the at least one coefficient group is outside of the lowest frequency region of the transform block; and coding the video data based at least in part on the determination not to code the syntax element indicative of the multiple transform selection for the transform block.

In another example, this disclosure describes a device for coding data includes means for determining, for a transform block of video data, that at least one coefficient group, of the transform block, that comprises a non-zero transform coefficient is outside of a lowest frequency region of the transform block, wherein the at least one coefficient group is one of a plurality of coefficient groups that each comprise transform coefficients; means for determining not to code a syntax element indicative of a multiple transform selection (MTS) for the transform block based at least in part on the determination of that the at least one coefficient group is outside of the lowest frequency region of the transform block; and means for coding the video data based at least in part on the determination not to code the syntax element indicative of the multiple transform selection for the transform block.

In another example, this disclosure describes a computer-readable storage medium having stored thereon instructions that, when executed, cause one or more processors to: determine, for a transform block of video data, that at least one coefficient group, of the transform block, that comprises a non-zero transform coefficient is outside of a lowest frequency region of the transform block, wherein the at least one coefficient group is one of a plurality of coefficient groups that each comprise transform coefficients; determine not to code a syntax element indicative of a multiple transform selection (MTS) for the transform block based at least in part on the determination of that the at least one coefficient group is outside of the lowest frequency region of the transform block; and code the video data based at least in part on the determination not to code the syntax element indicative of the multiple transform selection for the transform block.

In another example, this disclosure describes a device. The device includes a memory; and a processor implemented in circuitry and configured to: determine, for a transform block of video data, that at least one coefficient group, of the transform block, that comprises a non-zero transform coefficient is outside of a lowest frequency region of the transform block, wherein the at least one coefficient group is one of a plurality of coefficient groups that each comprise transform coefficients; determine not to code a syntax element indicative of a multiple transform selection (MTS) for the transform block based at least in part on the determination of that the at least one coefficient group is outside of the lowest frequency region of the transform block; and code the video data based at least in part on the determination not to code the syntax element indicative of the multiple transform selection for the transform block.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIGS. 2A and 2B are conceptual diagrams illustrating an example quadtree binary tree (QTBT) structure, and a corresponding coding tree unit (CTU).

FIGS. 3A and 3B are conceptual diagrams illustrating an example transform scheme based on a residual quadtree of HEVC.

FIGS. 4A and 4B are conceptual diagrams illustrating horizontal and vertical transforms as a separate transform implementation.

FIG. 5 is a conceptual diagram illustrating transform signaling.

FIGS. 6A and 6B are conceptual diagrams illustrating transform blocks.

FIG. 7 is a block diagram illustrating an example video encoder that may perform the techniques of this disclosure.

FIG. 8 is a block diagram illustrating an example video decoder that may perform the techniques of this disclosure.

FIG. 9 is a flowchart illustrating an example method for encoding a current block in accordance with the techniques of this disclosure.

FIG. 10 is a flowchart illustrating an example method for decoding a current block in accordance with the techniques of this disclosure.

FIG. 11 is a flowchart illustrating an example method for determining whether to code a multiple transform selection.

### DETAILED DESCRIPTION

This disclosure relates to transform coding. In transform coding, for a video encoder there is a block of residual data (e.g., residual between current block being encoded and prediction block). The residual data is transformed from the spatial domain to a frequency domain resulting in a transform coefficient block (also referred to herein as a transform block) of transform coefficients. The video decoder receives the transform coefficient block (or possibly a transform coefficient block after quantization) and performs inverse quantization (if needed) and inverse transform to reconstruct the residual data back to the spatial domain of values.

A transform unit (TU) includes a transform block of luma samples and transform blocks of corresponding chroma samples. A transform block may be a rectangular M×N block of samples resulting from a transform in the decoding process, and the transform may be a part of the decoding process by which a block of transform coefficients is converted to a block of spatial domain values. Accordingly, a residual block may be an example of a TU. The residual block may be residual data transformed from sample domain to frequency domain and includes a plurality of transform coefficients. Transform coding is described in more detail in M. Wien, High Efficiency Video Coding: Coding Tools and Specification, Springer-Verlag, Berlin, 2015.

As described in more detail, the techniques described in one or more examples described in this disclosure utilizes a transform scheme called adaptive multiple (or multi-core) transform (AMT) or multiple transform selection (MTS). AMT and MTS may refer to the same transform tools as, due to a name change between video coding standards, AMT is now referred to as MTS, and the techniques described herein with respect MTS are equally applicable to AMT. The following U.S. patent applications describe multiple transform selection (MTS) techniques: U.S. Pat. No. 10,306,229 issued on May 28, 2019, U.S. Patent Publication No. 2018/0020218, published Jan. 18, 2018, and U.S. patent application Ser. No. 16/426,749, filed May 30, 2019. MTS techniques are generally the same as previously-described AMT techniques. An example of MTS described in U.S. patent application Ser. No. 16/426,749, filed May 30, 2019, has been adopted in the Joint Experimental Model (JEM-7.0) of the Joint Video Experts Team (JVET) (See Joint Video Experts Team (JVET) of ITU-T SG 16 WP 3 and ISO/IEC JTC 1/SC 29/WG 11, JEM Software, https://jvet.hhi.fraunhofer.de/svn/svn_HMJEMSoftware/tags/HM-16.6-JEM-7.0), and later a simplified version of MTS is adopted in VVC.

As described in more detail, in some examples, according to the techniques of MTS, an MTS index can be signaled to specify which transform kernels are applied along the horizontal and vertical direction of an associated luma transform block in the current coding unit. However, the MTS index may only be signaled if there are no non-zero transform coefficients (e.g., only zero valued transform coefficients) that is positioned outside of a lowest frequency region of the transform block. If there are non-zero transform coefficients outside of the lowest frequency region of the transform block, then the MTS index is not signaled. Instead, the value of the MTS index may be inferred to determine the applicable transform kernels.

Aspects of this disclosure describe techniques for determining whether to signal an MTS index for a transform block in ways that ensure that the MTS index is signaled only if there are no non-zero transform coefficients positioned outside of the lowest frequency region of the transform block. For example, a video coder, such as a video encoder or a video decoder, may determine whether there it at least one non-zero transform coefficients that is outside of a lowest frequency region of the transform block by determining whether a last coded coefficient group of a plurality of coefficient groups comprising transform coefficients for a transform block of video data is outside of a lowest frequency region of the transform block. The video coder may determine whether to code a syntax element indicative of a MTS index for the transform block based at least in part on the determination of whether the last coded coefficient group is positioned outside of the lowest frequency region of the transform block. The video coder may therefore code the video data based at least in part on the determination of whether to code the syntax element indicative of the multiple transform selection.

In this way, the techniques described in this disclosure prevents the MTS index to be signaled if there are non-zero transform coefficients outside of the lowest frequency region of the transform block, thereby preventing redundant signaling of MTS indexes for transform blocks having non-zero transform coefficients outside of the lowest frequency regions of the transform blocks. By reducing the amount of redundant data that may be signaled, the techniques described in this disclosure can improve coding efficiency of video data and can be used in advanced video codecs including extensions of HEVC and the next generation of video coding standards such as VVC.

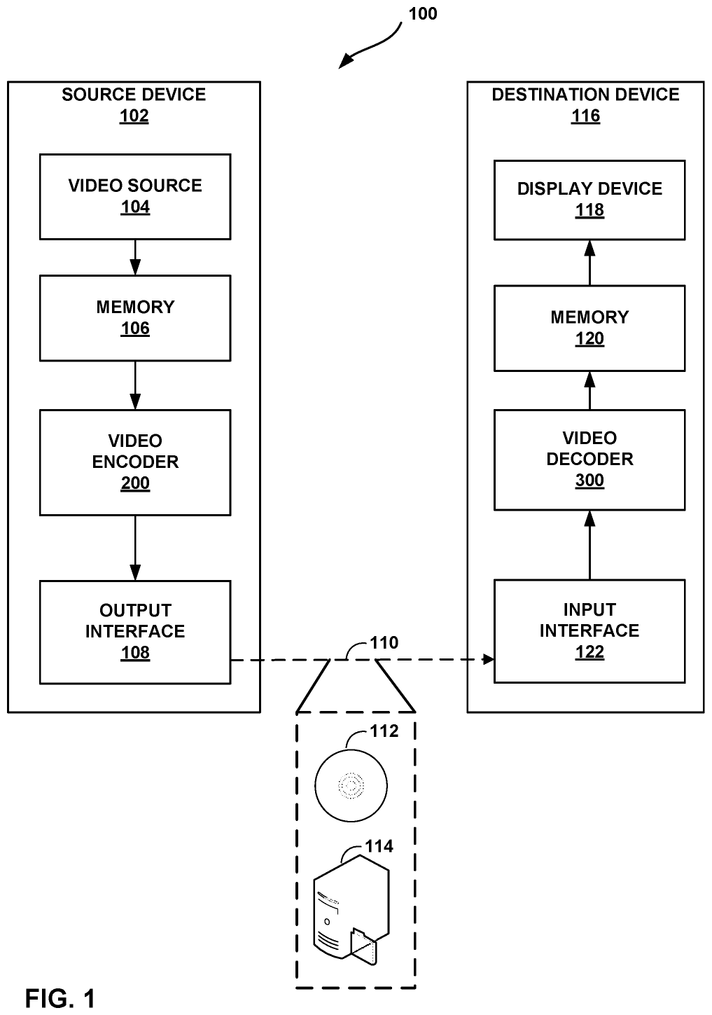

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for determining whether to code an MTS index for a transform block. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for determining whether to code an MTS index for a transform block. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). A draft of the VVC standard is described in Bross, et al. “Versatile Video Coding (Draft 10),” Joint Video Experts Team (JVET) of ITU-T SG 16 WP 3 and ISO/IEC JTC 1/SC 29/WG 11, 18^{th} Meeting: by teleconference, 22 Jun.-1 Jul. 2020, JVET-52001-vA (hereinafter “VVC Draft 10”). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning per HEVC, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile.

The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

In accordance with the techniques of this disclosure, video encoder 200 and video decoder 300 may determine, for a transform block of video data, whether at least one coefficient group, of the transform block, that comprises a non-zero transform coefficient is outside of a lowest frequency region of the transform block, where the at least one coefficient group is one of a plurality of coefficient groups that each comprise transform coefficients, determine whether to code a syntax element indicative of a multiple transform selection (MTS) for the transform block based at least in part on the determination of whether at least one coded coefficient group is outside of the lowest frequency region of the transform block, and code the video data based at least in part on the determination of whether to code the syntax element indicative of the multiple transform selection.

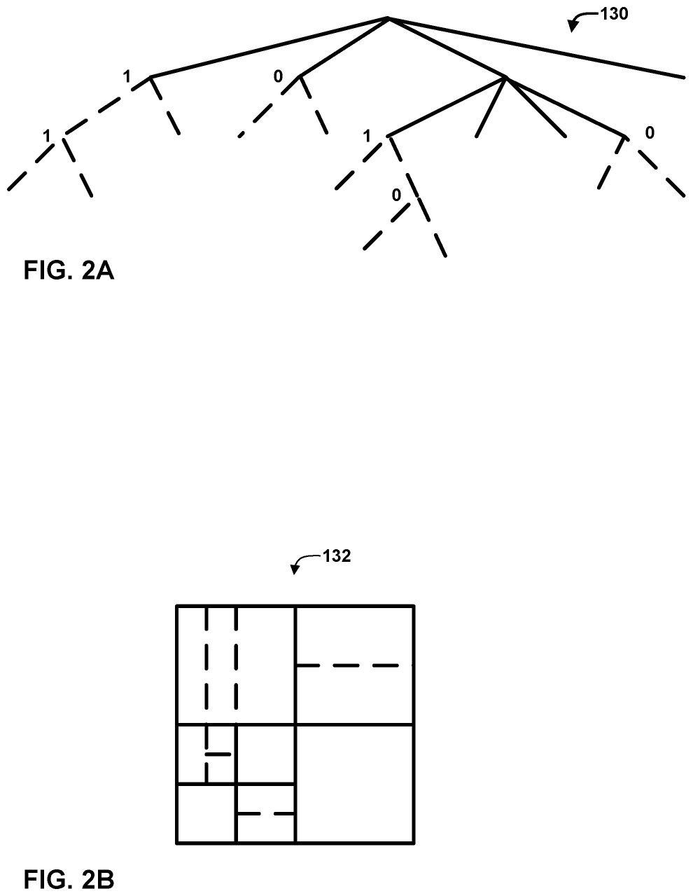

FIGS. 2A and 2B are conceptual diagrams illustrating an example quadtree binary tree (QTBT) structure 130, and a corresponding coding tree unit (CTU) 132. The solid lines represent quadtree splitting, and dotted lines indicate binary tree splitting. In each split (i.e., non-leaf) node of the binary tree, one flag is signaled to indicate which splitting type (i.e., horizontal or vertical) is used, where 0 indicates horizontal splitting and 1 indicates vertical splitting in this example. For the quadtree splitting, there is no need to indicate the splitting type, because quadtree nodes split a block horizontally and vertically into 4 sub-blocks with equal size. Accordingly, video encoder 200 may encode, and video decoder 300 may decode, syntax elements (such as splitting information) for a region tree level of QTBT structure 130 (i.e., the solid lines) and syntax elements (such as splitting information) for a prediction tree level of QTBT structure 130 (i.e., the dashed lines). Video encoder 200 may encode, and video decoder 300 may decode, video data, such as prediction and transform data, for CUs represented by terminal leaf nodes of QTBT structure 130.

In general, CTU 132 of FIG. 2B may be associated with parameters defining sizes of blocks corresponding to nodes of QTBT structure 130 at the first and second levels. These parameters may include a CTU size (representing a size of CTU 132 in samples), a minimum quadtree size (MinQTSize, representing a minimum allowed quadtree leaf node size), a maximum binary tree size (MaxBTSize, representing a maximum allowed binary tree root node size), a maximum binary tree depth (MaxBTDepth, representing a maximum allowed binary tree depth), and a minimum binary tree size (MinBTSize, representing the minimum allowed binary tree leaf node size).

The root node of a QTBT structure corresponding to a CTU may have four child nodes at the first level of the QTBT structure, each of which may be partitioned according to quadtree partitioning. That is, nodes of the first level are either leaf nodes (having no child nodes) or have four child nodes. The example of QTBT structure 130 represents such nodes as including the parent node and child nodes having solid lines for branches. If nodes of the first level are not larger than the maximum allowed binary tree root node size (MaxBTSize), then the nodes can be further partitioned by respective binary trees. The binary tree splitting of one node can be iterated until the nodes resulting from the split reach the minimum allowed binary tree leaf node size (MinBTSize) or the maximum allowed binary tree depth (MaxBTDepth). The example of QTBT structure 130 represents such nodes as having dashed lines for branches. The binary tree leaf node is referred to as a coding unit (CU), which is used for prediction (e.g., intra-picture or inter-picture prediction) and transform, without any further partitioning. As discussed above, CUs may also be referred to as “video blocks” or “blocks.”

In one example of the QTBT partitioning structure, the CTU size is set as 128×128 (luma samples and two corresponding 64×64 chroma samples), the MinQTSize is set as 16×16, the MaxBTSize is set as 64×64, the MinBTSize (for both width and height) is set as 4, and the MaxBTDepth is set as 4. The quadtree partitioning is applied to the CTU first to generate quad-tree leaf nodes. The quadtree leaf nodes may have a size from 16×16 (i.e., the MinQTSize) to 128×128 (i.e., the CTU size). If the quadtree leaf node is 128×128, the leaf quadtree node will not be further split by the binary tree, because the size exceeds the MaxBTSize (i.e., 64×64, in this example). Otherwise, the quadtree leaf node will be further partitioned by the binary tree. Therefore, the quadtree leaf node is also the root node for the binary tree and has the binary tree depth as 0. When the binary tree depth reaches MaxBTDepth (4, in this example), no further splitting is permitted. A binary tree node having a width equal to MinBTSize (4, in this example) implies that no further vertical splitting (that is, dividing of the width) is permitted for that binary tree node. Similarly, a binary tree node having a height equal to MinBTSize implies no further horizontal splitting (that is, dividing of the height) is permitted for that binary tree node. As noted above, leaf nodes of the binary tree are referred to as CUs, and are further processed according to prediction and transform without further partitioning.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

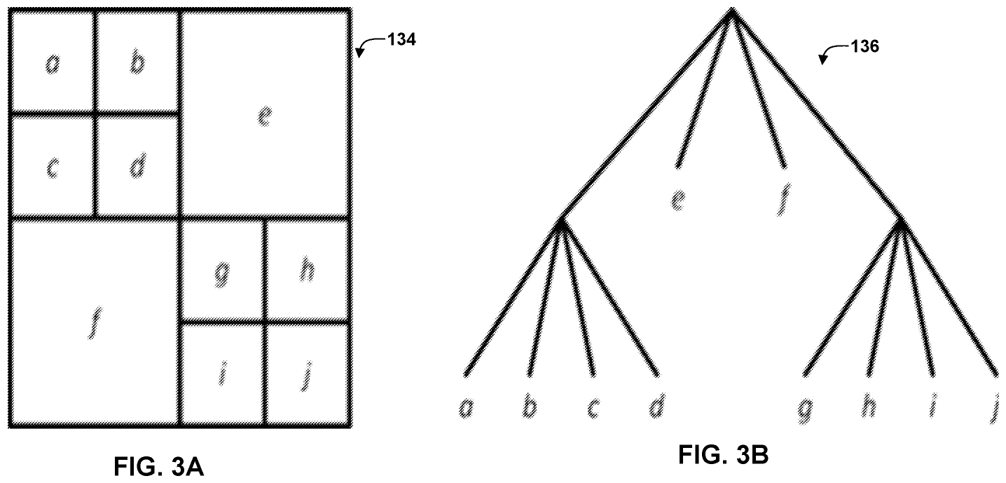

FIGS. 3A and 3B are conceptual diagrams illustrating an example transform scheme based on a residual quadtree of HEVC. In HEVC, a transform coding structure using the residual quadtree (RQT) is applied to adapt various characteristics of residual blocks, which is briefly described in J. Han, A. Saxena and K. Rose, “Towards jointly optimal spatial prediction and adaptive transform in video/image coding,” IEEE International Conference on Acoustics, Speech and Signal Processing (ICASSP), March 2010, pp. 726-729. Additional information about RQT is available at: http://www.hhi.fraunhofer.de/fields-of-competence/image-processing/research-groups/image-video-coding/hevc-high-efficiency-video-coding/transform-coding-using-the-residual-quadtree-rqt.html.

In RQT, each picture is divided into coding tree units (CTU), which are coded in raster scan order for a specific tile or slice. A CTU is a square block and represents the root of a quadtree, i.e., the coding tree. The CTU size may range from 8×8 to 64×64 luma samples, but typically 64×64 is used. Each CTU can be further split into smaller square blocks called coding units (CUs). After the CTU is split recursively into CUs, each CU is further divided into prediction units (PU) and transform units (TU). The partitioning of a CU into TUs is carried out recursively based on a quadtree approach, therefore the residual signal of each CU is coded by a tree structure namely, the residual quadtree (RQT). The RQT allows TU sizes from 4×4 up to 32×32 luma samples.

FIG. 3A depicts an example where CU 134 includes 10 TUs, labeled with the letters a to j, and the corresponding block partitioning. Each node of RQT 136 shown in FIG. 3B is a transform unit (TU) corresponding to FIG. 3A. The individual TUs are processed in depth-first tree traversal order, which is illustrated in FIG. 3A as alphabetical order, which follows a recursive Z-scan with depth-first traversal. The quadtree approach enables the adaptation of the transform to the varying space-frequency characteristics of the residual signal.

Typically, larger transform block sizes, which have larger spatial support, provide better frequency resolution. However, smaller transform block sizes, which have smaller spatial support, provide better spatial resolution. The trade-off between the two, spatial and frequency resolutions, is chosen by the encoder mode decision, for example based on rate-distortion optimization technique. The rate-distortion optimization technique calculates a weighted sum of coding bits and reconstruction distortion, i.e., the rate-distortion cost, for each coding mode (e.g., a specific RQT splitting structure), and select the coding mode with least rate-distortion cost as the best mode.

Three parameters are defined in the RQT: the maximum depth of the tree, the minimum allowed transform size and the maximum allowed transform size. The minimum and maximum transform sizes can vary within the range from 4×4 to 32×32 samples, which correspond to the supported block transforms mentioned in the previous paragraph. The maximum allowed depth of the RQT restricts the number of TUs. A maximum depth equal to zero means that a coding block (CB) cannot be split any further if each included TB reaches the maximum allowed transform size, e.g., 32×32.

All these parameters interact and influence the RQT structure. Consider a case in which the root CB size is 64×64, the maximum depth is equal to zero and the maximum transform size is equal to 32×32. In this case, the CB is to be partitioned at least once, since otherwise it would lead to a 64×64 TB, which is not allowed. The RQT parameters, i.e. maximum RQT depth, minimum and maximum transform size, are transmitted in the bitstream at the sequence parameter set level. Regarding the RQT depth, different values can be specified and signaled for intra and inter coded CUs.

The quadtree transform is applied for both Intra and Inter residual blocks. Typically, the DCT-II transform of the same size of the current residual quadtree partition is applied for a residual block. However, if the current residual quadtree block is 4×4 and is generated by Intra prediction, the above 4×4 DST-VII transform is applied.

In HEVC, larger size transforms, e.g., 64×64 transform are not adopted mainly due to its limited benefit considering and relatively high complexity for relatively smaller resolution videos.

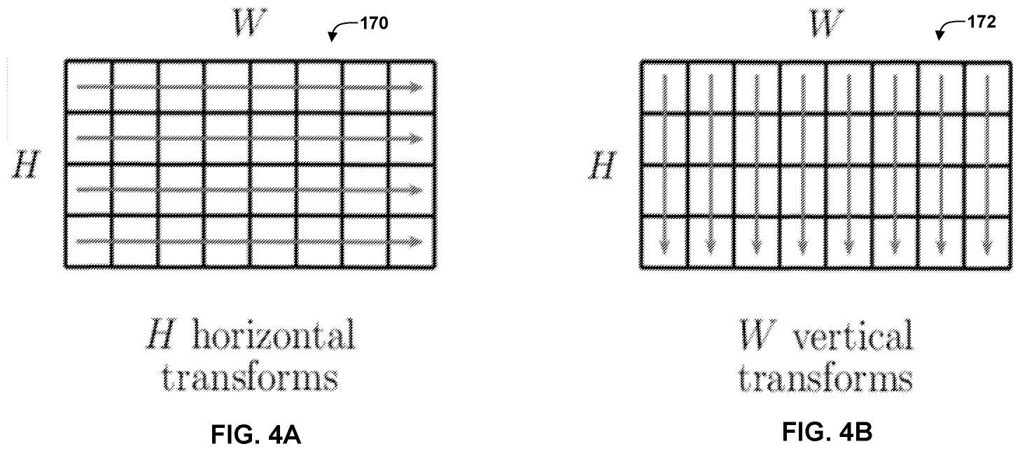

To reduce computational complexity, the block transforms are commonly computed in a separable manner, i.e., the horizontal and vertical lines are transformed independently, as shown in FIGS. 4A and 4B. FIGS. 4A and 4B are conceptual diagrams illustrating horizontal and vertical transforms as a separable transform implementation. FIG. 4A represents a set of H horizontal transforms 170, while FIG. 4B represents a set of W vertical transforms 172. In particular, horizontal and vertical lines of residual values may be transformed independently using the horizontal transforms 170 and vertical transforms 172, respectively.

In video coding standards prior to HEVC, only a fixed separable transform is used, where DCT-2 is used both vertically and horizontally. In HEVC, in addition to DCT-2, DST-7 is also employed for 4×4 blocks as a fixed separable transform. U.S. Patent Publication No. 2016/0219290 and U.S. Patent Publication No. 2018/0020218 cover adaptive extensions of those fixed transforms, and an example of AMT in U.S. Patent Publication No. 2016/0219290 has been adopted in the Joint Experimental Model (JEM) of the Joint Video Experts Team (JVET) X. Zhao, J. Chen, M. Karczewicz, L. Zhang, X. Li, and W.-J. Chien, “Enhanced multiple transform for video coding,” Proc. Data Compression Conference, pp. 73-82, March 2016.

The AMT designs described in U.S. Patent Publication No. 2016/0219290 and U.S. Patent Publication No. 2018/0020218 offer 5 transform options for video encoder 200 to select on a per-block basis (this selection is generally done based on a rate-distortion metric). Then, the selected transform index is signaled to video decoder 300.

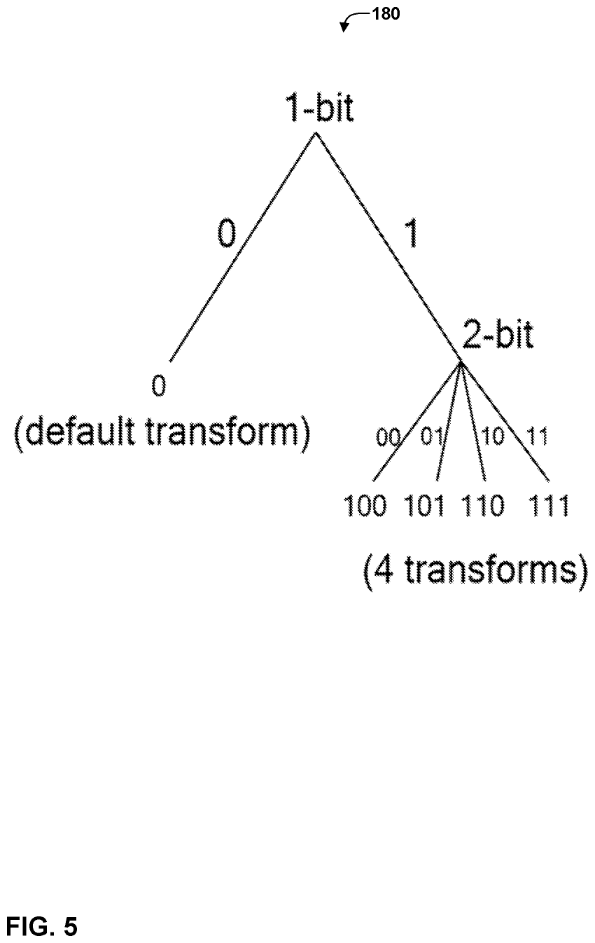

FIG. 5 is a conceptual diagram illustrating transform signaling. For example, FIG. 5 illustrates the signaling proposed in U.S. Patent Publication No. 2016/0219290 and U.S. Patent Publication No. 2018/0020218 where 1-bit is used to signal the default transform and 2 additional bits (i.e., 3 bits in total) are used to signal 4 transforms. For example, one of five transforms (default transforms) is signaled using 0 (i.e., 1-bit) and the other four transforms are signaled using 3-bits (i.e., 100, 101, 110, and 111).

In U.S. Patent Publication No. 2016/0219290 and U.S. Patent Publication No. 2018/0020218, the default transform is selected as the separable 2-D DCT, which applies DCT-2 both vertically and horizontally. The rest of the AMTs are defined based on intra-mode information in U.S. Patent Publication No. 2016/0219290. U.S. Patent Publication No. 2018/0020218 proposes an extension of U.S. Patent Publication No. 2016/0219290 by defining the set of those 4 transforms based on both prediction mode and block size information.

In a version of VVC reference software, VTM 3.0, the signaling scheme illustrated in FIG. 5 is used. For each coding unit (CU), a single bit (a flag) is used to determine whether (i) DCT2 is used in both horizontal and vertical direction or (ii) two additional bits (called AMT/MTS indexes) are used to specify the 1-D transforms applied horizontally or vertically. These 4 transforms are defined by assigning DST-7/DCT-8 to be applied on rows/columns of a given block. For example, the two additional bits having a value of 00 may correspond to the separable transform that applies DST-7 both horizontally and vertically, and the two additional bits having a value of 01 may correspond to applying DCT-8 horizontally and DST-7 vertically.

Throughout this disclosure, a MTS index may be a syntax element that specifies the separable transforms that are applied along the horizontal and vertical direction of the associated luma transform blocks in the current coding unit. In some examples, a MTS index may be the leadint 1-bit value or the 3-bit value as described above with respect to FIG. 5. In other examples, a MTS index may be one or more bits that specifies any suitable multiple transforms.

According to the techniques of MTS, a MTS index can be signaled to specify which transform kernels are applied along the horizontal and vertical direction of an associated luma transform block in the current coding unit. However, the MTS index may only be signaled if there are no non-zero transform coefficients for the transform block outside of a lowest frequency region of the transform block, which may be an upper-left region of the transform block, such as a 16×16 top-left region of a 32×32 transform block. If there are non-zero transform coefficients outside of the lowest frequency region of the transform block, then the MTS index is not signaled. Instead, the value of the MTS index may be inferred to determine the applicable transform kernels.

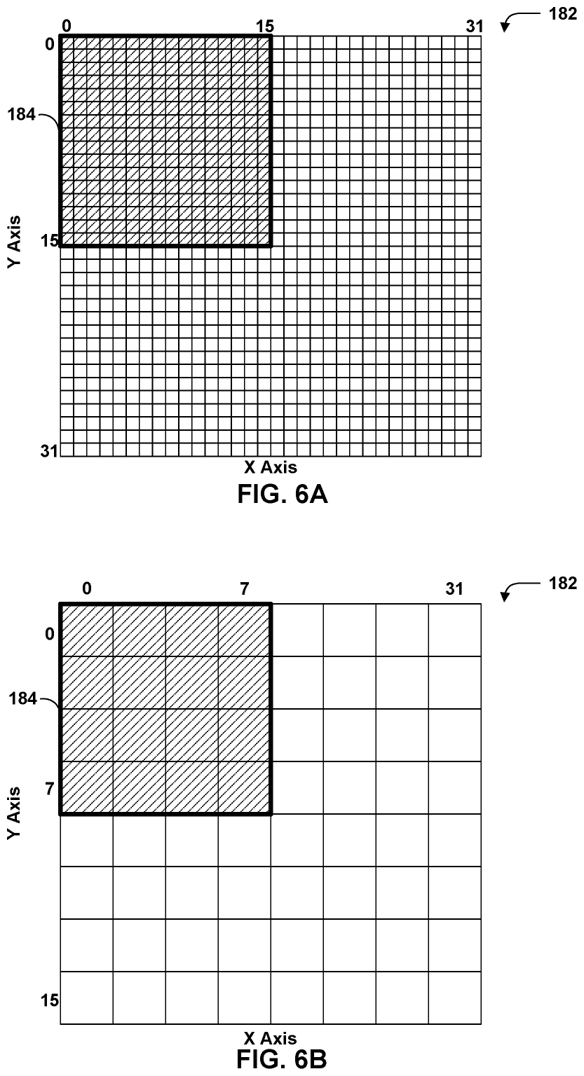

FIGS. 6A and 6B are conceptual diagrams illustrating transform blocks. As shown in FIG. 6A, transform block 182 may comprise 32×32 samples. While FIG. 6A illustrates transform block 182 as comprising 32×32 samples, the techniques described in this disclosure may be applicable to any transform block comprise N×M samples, where M is not necessarily equal to N. Transform block 182 may include lowest frequency region 184 (which is shaded in FIG. 6A), which may be an upper-left portion (e.g., upper-left sub-block) of transform block 182 representing the lowest frequency transform coefficients of the transform block 182. In the example of FIG. 6A, lowest frequency region 184 of transform block 182 may be the upper-left 16×16 samples of transform block 182 that spans from 0 to 15 on both the x-axis and the y-axis.

As one example, transform block 182 may be generated based on a DCT or DST transform. One possible result of the DCT or DST transform that the transform coefficients are ordered based on their respective frequencies. For example, transform coefficients associated with low frequency tend to be gathered in the upper-left portion of transform block 182. Accordingly, lowest frequency region 184 includes transform coefficients associated with low frequency.

In some examples, an MTS index (i.e., a syntax element indicative of a multiple transform selection) that indicates the multiple transforms (i.e., separable transforms) selected for transform block 182 only if transform coefficients in transform block 182 that are outside of lowest frequent region 184 in the transform block 182 each have a value of zero. If none of the coefficient groups outside of the lowest frequent region 184 in the transform block 182 contains a non-zero transform coefficient, then video encoder 200 may encode an MTS index that indicates the multiple transforms selected for the transform block 182, and video decoder 300 may decode the MTS index for transform block 182.

However, if at least one transform coefficient outside of lowest frequent region 184 in the transform block 182 has a non-zero value, then video encoder 200 may determine not to encode an MTS index that indicates the multiple transforms selected for the transform block 182, and video decoder 300 may instead infer (e.g., determine without an explicit syntax element) that the value of the MTS index is a default value, such as zero, and may apply a default transform (e.g., a DCT-2 transform), to the transform block

In VVC Draft 7, draft 14 (i.e., WET-P2001-vE), an MTS index, referred to below as “mts_idx”, is signaled if the following set of conditions are satisfied:

TABLE 1

| | |
|---|---|
| if( treeType != DUAL_TREE_CHROMA && lfnst_idx = = 0 && | |
| transform_skip_flag[ x0 ][ y0 ][ 0 ] = = 0 && Max( cbWidth, cbHeight ) <= | |
| 32 && | |
| IntraSubPartitionsSplit[ x0 ][ y0 ] = = ISP_NO_SPLIT && cu_sbt_flag = = 0 | |
| && | |
| MtsZeroOutSigCoeffFlag = = 1 && tu_cbf luma[ x0 ][ y0 ] ) { | |
| if( ( ( CuPredMode[ chType ][ x0 ][ y0 ] = = MODE_INTER && | |
| sps_explicit_mts_inter_enabled_flag ) \| \| | |
| ( CuPredMode[ chType ][ x0 ][ y0 ] = = MODE_INTRA && | |
| sps_explicit_mts_intra_enabled_flag ) ) ) | |
| mts_idx | ae(v) |
| } | |

As can be seen in Table 1, a video coder (e.g., video encoder 200 and/or video decoder 300) may determine whether the syntax element mts_idx is signaled based at least in part on whether the value of the syntax element MtsZeroOutSigCoeffFlag is equal to one. If the value syntax element MtsZeroOutSigCoeffFlag is equal to one, then the video coder may signal the syntax element mts_idx. If the value of syntax element MtsZeroOutSigCoeffFlag is not equal to one, such as when the value of syntax element MtsZeroOutSigCoeffFlag is zero, then the video coder may not signal the syntax element mts_idx. Instead, the video coder may infer a value for the MTS index, such as 0. The inferred value of the MTS index may correspond to the selection of a specific transform, such as a DCT-2 transform for both the horizontal and vertical transforms.

The value of the syntax element MtsZeroOutSigCoeffFlag indicates whether the values of the coefficients of a transform block that are outside of the lowest frequency region of the transform block are zeroed-out (i.e., each have a value of zero). In some examples, for a 32×32 transform block 182, the lowest frequency region 184 is the upper-left 16×16 region of the transform block, which spans from position (0, 0) of transform block 182 to position (15, 15) of transform block 182.

As such, in VVC Draft 7, draft 14, the value of the syntax element MtsZeroOutSigCoeffFlag in Table 1 is set to zero according to the following conditions depending on the position of the last significant coefficient:

TABLE 2

if( ( LastSignificantCoeffX > 15 | | LastSignificantCoeffY > 15) &&
cIdx = = 0)
MtsZeroOutSigCoeffFlag = 0

As can be seen in Table 2, the video coder may determine the value of the syntax element MtsZeroOutSigCoeffFlag based on the position (e.g., the position on the x-axis and the y-axis) of the last significant (i.e., non-zero) coefficient in the transform block 182. To determine if the position of the last significant coefficient of a 32×32 transform block 182 is outside of the 16×16 lowest frequency region 184, the video coder checks whether the position of the last significant coefficient is greater than 15 on the x-axis and on the y-axis, where the value of the syntax element LastSignificantCoeffX is the position of the last significant coefficient on the x-axis in the transform block 182, and where LastSignificantCoeffY is the position of the last significant coefficient on the y-axis in the transform block 182.

If the position of the last significant coefficient is greater than 15 on at least one of the x-axis or the y-axis, then the video coder may determine that the values of the coefficients of a transform block 182 that are outside of the lowest frequency region 184 of the transform block 182 are not zeroed-out and may therefore set the value of the syntax element MtsZeroOutSigCoeffFlag to zero. If the position of the last significant coefficient is not greater than 15 on either the x-axis or the y-axis, then the video coder may determine that the values of the coefficients of a transform block 182 that are outside of the lowest frequency region 184 of the transform block 182 are zeroed-out and may therefore set the value of the syntax element MtsZeroOutSigCoeffFlag to one.

However, the position of the last significant coefficient in the transform block 182 may not always be a reliable indicator of whether the values of the coefficients of a transform block 182 that are outside of the lowest frequency region 184 of the transform block 182 are zeroed-out. There may be situations where the values of the coefficients of a transform block 182 that are outside of the lowest frequency region 184 of the transform block 182 are not zeroed-out even if the last significant coefficient in the transform block 182 is within the lowest frequency region 184.

For example, because the video coder determines the last significant coefficient of a transform block 182 via diagonal scanning of the coefficients of a transform block 182, it is possible for a non-zero coefficient outside the lowest frequency region 184 in the transform block 182 to be scanned prior to scanning a last significant coefficient that is in the lowest frequency region 184 in the transform block 182. In this example, even though a non-zero coefficient exists outside the lowest frequency region 184 in the transform block 182, the video coder may nevertheless determine that, because the last significant coefficient is in the lowest frequency region 184 in the transform block 182, that there are no non-zero coefficient values outside of the lowest frequency region 184 of the transform block 182.

In order to resolve this problem, the video bitstream can be restricted as follows: It is a requirement of bitstream conformance that mts_idx shall be equal to 0 if in the current coding unit at least one coded_sub_block_flag[xS][yS] in the residual coding(x0, y0, log 2sTbWidth, log 2TbHeight, cIdx) syntax structure is not equal to 0 for cIdx equal to 0 and xS or yS greater than 3. However, a bitstream restriction may not guarantee that a non-conforming video encoder will not still signal the MTS index for a transform block 182 even if the transform block 182 contains non-zero coefficients outside the lowest frequency region 184 of the transform block 182.

As such, aspects of the present disclosure describe transform signaling techniques for replacing the bitstream restriction for MTS signaling as described above with a syntax-based restriction. For example, instead of using the position of the last significant coefficient position to restrict signaling of the MTS index, the signaling of the MTS index may be restricted based on the location of the last coded coefficient group (CG), where a coded CG is a CG that contains at least one non-zero coefficient, so that (i) potential redundant signaling of MTS is avoided, and (ii) a non-zero coefficient outside top-left 16×16 region in a 32×32 TU is not possible when MTS is used (e.g., when a combination of DST-7 and DCT-8 is used as the separable transform).

In some examples, a CG may be a set of consecutive coefficients in scan order. For example, a CG may be a set of 16 consecutive coefficients in scan order, such that a CG may correspond to a 4×4 sub-block of the transform block 182. In this example, a 32×32 TU may include 64 non-overlapping CGs. Other examples of a CG may be equally applicable to the techniques disclosed herein.

As shown in FIG. 6B, in the example of a 32×32 transform block 182 having 4×4 coefficient groups, the positions of CGs in the transform block 182 are denoted as (x, y), where x and y may each range from 0 to 7, such that the position of CGs in the transform block 182 may range from (0, 0) to (7, 7). Thus, the 16×16 lowest frequency region 184 of the transform block 182 may span (0, 0) to (3, 3) in the transform block 182, and a CG is therefore outside of the lowest frequency region 184 of the transform block 182 if the position of the CG along at least one of the x-axis and the y-axis is greater than three.

As such, in some aspects of this disclosure, the video coder is not allowed to signal the MTS index (i.e., the syntax element mts_idx), and the value of the MTS index is inferred as 0 (i.e., inferred that DCT-2 is used as the horizontal and vertical transforms of the coefficient block) if the position of the last coded CG along the x-axis or y-axis is greater than three. Otherwise, if no CG in the transform block 182 has a position that is greater than three along at least one of the x-axis and the y-axis, the video coder may signal the MTS index.

In accordance with aspects of the present disclosure, a video coder may determine to not signal the MTS index for a transform block 182, such that the value of the MTS index is instead inferred as a default value (e.g., inferring the value of the MTS index to be 0 to denote the selection of a DCT-2 transform) if the position of the last coded CG in the x-axis or y-axis is greater than three. Otherwise, if no coded CG has a position in either the x-axis or the y-axis that is greater than three, then the MTS index may be signaled, such as by video encoder 200. Similarly, if no coded CG has a position in either the x-axis or the y-axis that is greater than three, then the MTS index may be parsed, such as by video decoder 300 to determine the selected separable transforms for the transform block 182. Three may be just one example of the threshold value of the last coded CG in the x-axis and y-axis for determining whether the MTS index may be signaled/parsed, and depending on any suitable factors (e.g., size of the transform block 182) values different than three may be equally applicable to the techniques disclosed.

The sections of VVC Draft 7, draft 14 that may be improved in this disclosure are shown in below in Table 3. Video encoder 200 may determine whether to signal the MTS index for a transform block 182 based on the coding syntax shown in Table 1 and video decoder 300 may determine whether to infer the MTS index for a transform block 182 and/or whether to parse an encoded MTS index based on the coding syntax shown in Table 1.

The syntax changes to VVC Draft 7, version 14 are described in Table 3, where content between <DELETE></DELETE> are deleted from the residual coding syntax and/or from the slice data semantics, while content between <ADD></ADD> are added to the residual coding syntax and/or to the slice data semantics. in accordance with the techniques of this disclosure, and such tags are not actually part of the residual coding syntax. Similarly, <ADD>, </ADD>, <DELETE>, and </DELETE> are added purely for readability purposes in this disclosure in order to denote syntax that has been deleted from the residual coding syntax, in accordance with the techniques of this disclosure, and such tags are not actually part of the residual coding syntax.

TABLE 3
Section 7.3.9.11 Residual coding syntax in VCC Draft 7, Version 14

Descriptor

residual_coding( x0, y0, log2TbWidth, log2TbHeight, cIdx ) {

...
do {

if( lastScanPos = = 0 ) {

lastScanPos = numSbCoeff
lastSubBlock− −

}
lastScanPos− −
xS = DiagScanOrder[ log2TbWidth − log2SbW ][ log2TbHeight − log2SbH ]

[ lastSubBlock ][ 0 ]

yS = DiagScanOrder[ log2TbWidth − log2SbW ][ log2TbHeight − log2SbH ]

[ lastSubBlock ][ 1 ]

xC = ( xS << log2SbW ) +

DiagScanOrder[ log2SbW ][ log2SbH ][ lastScanPos ][ 0 ]

yC = ( yS << log2SbH ) +

DiagScanOrder[ log2SbW ][ log2SbH ][ lastScanPos ][ 1 ]

} while( ( xC != LastSignificantCoeffX ) | | ( yC != LastSignificantCoeffY ) )
if( lastSubBlock = = 0 && log2TbWidth >= 2 && log2TbHeight >= 2 &&

!transform_skip_flag[ x0 ][ y0 ][ cIdx ] && lastScanPos > 0 )
LfnstDcOnly = 0

if( ( lastSubBlock > 0 && log2TbWidth >= 2 && log2TbHeight >= 2 ) | |

( lastScanPos > 7 && ( log2TbWidth = = 2 | | log2TbWidth = = 3 ) &&
log2TbWidth = = log2TbHeight ) )
LfnstZeroOutSigCoeffFlag = 0

<DELETE>if( ( LastSignificantCoeffX > 15 | | LastSignificantCoeffY > 15 ) &&

cIdx = = 0 )</DELETE>

<DELETE>MtsZeroOutSigCoeffFlag = 0</DELETE>

QState = 0
for( i = lastSubBlock; i >= 0; i− − ) {

startQStateSb = QState
xS = DiagScanOrder[ log2TbWidth − log2SbW ][ log2TbHeight − log2SbH ]

[ i ][ 0 ]

yS = DiagScanOrder[ log2TbWidth − log2SbW ][ log2TbHeight − log2SbH ]

[ i ][ 1 ]

inferSbDcSigCoeffFlag = 0
if( i < lastSubBlock && i > 0 ) {

| | |
|---|---|
| coded_sub_block_flag[ xS ][ yS ] | ae(v) |
| inferSbDcSigCoeffFlag = 1 | |

}
<ADD>if( ( coded_sub_block_flag[ xS ][ yS ] | | i = = lastSubBlock ) &&

cIdx = = 0 &&

```
  ( xS > 3 | | yS > 3 ) {</ADD>
  <ADD>MtsZeroOutSigCoeffFlag = 0</ADD>
```

<ADD>}</ADD>
firstSigScanPosSb = numSbCoeff
lastSigScanPosSb = −1
firstPosMode0 = ( i = = lastSubBlock ? lastScanPos : numSbCoeff − 1 )
firstPosMode1 = firstPosMode0
for( n = firstPosMode0; n >= 0 && remBinsPass1 >= 4; n− − ) {

xC = ( xS << log2SbW ) + DiagScanOrder[ log2SbW ][ log2SbH ][ n ][ 0 ]
yC = ( yS << log2SbH ) + DiagScanOrder[ log2SbW ][ log2SbH ][ n ][ 1 ]
if( coded_sub_block_flag[ xS ][ yS ] && ( n > 0 | |

!inferSbDcSigCoeffFlag ) &&

| | |
|---|---|
| ( xC != LastSignificantCoeffX \| \| yC != Last SignificantCoeffY ) ) { | |
| sig_coeff_flag[ xC ][ yC ] | ae(v) |
| remBinsPass1− − | |
| if( sig_coeff_flag[ xC ][ yC ] ) | |

inferSbDcSigCoeffFlag = 0

}
if( sig_coeff_flag[ xC ][ yC ] ) {

| | |
|---|---|
| abs_level_gtx_flag[ n ][ 0 ] | ae(v) |
| remBinsPass1− − | |
| if( abs_level_gtx_flag[ n ][ 0 ] ) { | |

| | |
|---|---|
| par_level_flag[ n ] | ae(v) |
| remBinsPass1− − | |
| abs_level_gtx_flag[ n ][ 1 ] | ae(v) |
| remBinsPass1− − | |

}

...

...
7.4.10 Slice data semantics in VVC Draft 7, Version 14
...
mts_idx specifies which transform kernels are applied along the horizontal and vertical direction of the
associated luma transform block 182s in the current coding unit.
When mts_idx is not present, it is inferred to be equal to 0.
<DELETE>It is a requirement of bitstream conformance that mts_idx shall be equal to 0 if in the
current coding unit at least one coded_sub_block_flag[ xS ][ yS ] in the
residual_coding( x0, y0, log2TbWidth, log2TbHeight, cIdx ) syntax structure is not equal to 0 for cIdx
equal to 0 and xS or yS greater than 3.</DELETE>
When ResetIbcBuf is equal to 1, the following applies:
1. For x = 0..IbcBufWidthY − 1 and y = 0..CtbSizeY − 1, the following assignments are made:

| | |
|---|---|
| IbcVirBuf[ 0 ][ x ][ y ] = −1 | (175) |

...

As can be seen in Table 3, the syntax if((LastSignificantCoeffX>15 LastSignificantCoeffY>15) && cIdx==0), which checks whether the position of the last significant coefficient is outside the lowest frequency region 184 of the transform block 182, is deleted from the residual coding syntax. Instead, in order to determine the value of MtsZeroOutSigCoeffFlag for a transform block 182, a video coder (e.g., video encoder 200 or video decoder 300) may iterate through CGs in the transform block 182 to determine, for a CG, whether it is a coded CG (i.e., contains a non-zero coefficient) and, if the CG is a coded CG, determine whether the coded CG is outside of the lowest frequency region 184 of the transform block 182. If the video coder determines that the coded CG is outside of the lowest frequency region 184 of the transform block 182, the video coder may set the value of MtsZeroOutSigCoeffFlag for the transform block 182 to zero to indicate that coefficients outside of the lowest frequency region 184 of the transform block 182 are not zeroed-out.

The video coder may, for a transform block 182, traverse through CGs of the transform block 182 according to a scanning order (e.g., a diagonal scan order) starting from the last sub block. The video coder may, for each CG encountered by the video coder, determine whether the CG is a coded CG by determining whether a coded sub-block flag is set for the CG. As shown in Table 3, each CG encountered by the video coder is denoted to have a position of [xS][yS], where xS is the position of the CG along the x-axis in the transform block 182 and where yX is the position of the CG along the y-axis in the transform block 182.

As also shown in Table 3, a coded sub-block flag for a CG at position [xS][yS] is denoted as the syntax element coded_sub_block_flag[xS][yS]. The coded sub-block flag for a CG may have either a value of one or a value of zero. The coded sub-flock flag for a CG has a value of zero if all of the transform coefficients in the CG is zero, and the coded sub-block flag for a CG has a value of one if at least one of the transform coefficients in the CG is non-zero.

When the video coder encounters a CG, the video coder may determine, based on the value of the coded sub-block flag for the CG, whether the CG is a coded CG (contains a non-zero coefficient). For example, if the video coder determines that the value of the coded sub-block flag for the CG is one, the video coder may determine that the CG is a coded CG. If the video coder determines that the value of the coded sub-block flag for the CG is zero, the video coder may determine that the CG is not coded CG

The video coder may, in response to determining that a CG is a coded CG, determine whether the CG is positioned outside of the lowest frequency region 184 of the transform block 182. For a 64×64 transform block 182 with CGs as 4×4 sub-blocks, the position of CGs in the transform block 182 may range from (0, 0) to (7, 7), and the lowest frequency region 184 of the transform block 182 may span from (0, 0) to (3, 3). Thus, to determine whether a coded CG is positioned outside of the lowest frequency region 184 of the transform block 182, the video coder may determine whether the position of the coded CG in at least one of the x-axis or the y-axis is greater than three. If the video coder determines that the position of the coded CG in at least one of the x-axis or the y-axis is greater than three, the video coder may determine that at least one CG comprising a non-zero transform coefficient is outside of the lowest frequency region 184 of the transform block 182.

Given that a CG's position is denoted in the residual coding syntax as [xS][yS], the video coder may determine whether a coded CG is positioned outside the lowest frequency region 184 by determining whether the value of either xS or yS is greater than 3. If the video coder determines that the value of either xS or yS of the coded CG is greater than 3, the video coder may determine that at least one CG comprising a non-zero transform coefficient is outside of the lowest frequency region 184 of the transform block 182.

As can be seen in Table 3, the techniques of this disclosure adds the conditional syntax if((coded_sub_block_flag[xS][yS]∥i==lastSubBlock) && cIdx==0 && (xS>3 yS>3) MtsZeroOutSigCoeffFlag=0 to the residual coding syntax. The video coder performs the conditional syntax to check, for a CG, whether the CG is a coded CG based on determining whether the coded sub-block flag for the CG is set to one (coded_sub_block_flag[xS][yS]) and whether the position of the CG on at least one of the x-axis or the y-axis is greater than three (xS>3∥yS>3). If the video coder determines that the CG is a coded CG and that the position of the CG on at least one of the x-axis or the y-axis is greater than three, the video coder may determine that at least one non-zero transform coefficient is outside of the lowest frequency region 184 of the transform block 182, and may therefore set the value of the syntax element MtsZeroOutSigCoeffFlag to zero. If the video coder determines that the CG is not coded CG and/or that the position of the CG on neither the x-axis nor the y-axis is greater than three, the video coder may refrain from setting the value of the syntax element MtsZeroOutSigCoeffFlag

The video coder may therefore iterate through the CGs of a transform block 182 in scanning order, according to the techniques described above, in order to determine whether at least one CG comprising a non-zero transform coefficient is outside of the lowest frequency region 184 of the transform block 182. If the video coder, after iterating through the CGs of the transform block 182, determines that no CGs comprising a non-zero transform coefficient is outside of the lowest frequency region 184 of the transform block 182, the video coder may signal and/or parse an the MTS index for the transform block 182. That is, video encoder 200 may signal the MTS index to indicate the multiple transform to be applied to the transform block 182, and video decoder 300 may parse the MTS index to indicate the multiple transform to be applied to the transform block 182.

If the video coder, after iterating through the CGs of the transform block 182, determines that at least one CG comprising a non-zero transform coefficient is outside of the lowest frequency region 184 of the transform block 182, the video coder may refrain from signaling and/or parsing an the MTS index for the transform block 182. That is, video encoder 200 may determine not to signal the MTS index to indicate the multiple transform to be applied to the transform block 182. Similarly, video decoder 300 may infer a default value of the MTS index even if video encoder 200 signals the MTS index for the transform block 182.

As described above with conjunction to Table 1, the video coder may determine whether the MTS index (syntax element mts_idx) for a transform block 182 is signaled based at least in part on whether the value of the syntax element MtsZeroOutSigCoeffFlag is equal to one. If the value syntax element MtsZeroOutSigCoeffFlag is equal to one, then the video coder may signal the syntax element mts_idx. If the value of syntax element MtsZeroOutSigCoeffFlag is not equal to one, such as when the value of syntax element MtsZeroOutSigCoeffFlag is zero, then the video coder may not signal the syntax element mts_idx. Instead, the video coder may infer a value for the MTS index, such as 0. The inferred value of the MTS index may correspond to the selection of a specific transform, such as a DCT-2 transform for both the horizontal and vertical transforms. In this way, video encoder 200 may determine whether to signal the MTS index for a transform block 182 and video decoder 300 may determine whether to infer the MTS index for a transform block 182.

An alternative way of improving the techniques described in VVC Draft 7, draft 14 is shown in Table 4. for video encoder 200 to determine whether to signal the MTS index for a transform block 182 based on the coding syntax shown in Table 1 and for video decoder 300 to determine whether to infer the MTS index for a transform block 182 and/or whether to parse an encoded MTS index based on the coding syntax shown in Table 3.

Video encoder 200 may determine whether to signal the MTS index for a transform block 182 based on the coding syntax shown in Table 1 and video decoder 300 may determine whether to infer the MTS index for a transform block 182 and/or whether to parse an encoded MTS index based on the coding syntax shown in Table 1.

Alternative syntax changes to VVC Draft 7, version 14 are described in Table 4, where content between <DELETE></DELETE> are deleted from the residual coding syntax and/or from the slice data semantics, while content between <ADD></ADD> are added to the residual coding syntax and/or to the slice data semantics. in accordance with the techniques of this disclosure, and such tags are not actually part of the residual coding syntax. Similarly, <ADD>, </ADD>, <DELETE>, and </DELETE> are added purely for readability purposes in this disclosure in order to denote syntax that has been deleted from the residual coding syntax, in accordance with the techniques of this disclosure, and such tags are not actually part of the residual coding syntax.

TABLE 4
7.3.9.11 Residual coding syntax

Descriptor

residual_coding( x0, y0, log2TbWidth, log2TbHeight, cIdx ) {

...
numSbCoeff = 1 << ( log2SbW + log2SbH )
lastScanPos = numSbCoeff
lastSubBlock = ( 1 << ( log2TbWidth + log2TbHeight − ( log2SbW + log2SbH ) )

) − 1

do {

if( lastScanPos = = 0 ) {

lastScanPos = numSbCoeff
lastSubBlock− −

}
lastScanPos− −
xS = DiagScanOrder[ log2TbWidth − log2SbW ][ log2TbHeight − log2SbH ]

[ lastSubBlock ][ 0 ]

yS = DiagScanOrder[ log2TbWidth − log2SbW ][ log2TbHeight − log2SbH ]

[ lastSubBlock ][ 1 ]

xC = ( xS << log2SbW ) +

DiagScanOrder[ log2SbW ][ log2SbH ][ lastScanPos ][ 0 ]

yC = ( yS << log2SbH ) +

DiagScanOrder[ log2SbW ][ log2SbH ][ lastScanPos ][ 1 ]

} while( ( xC != LastSignificantCoeffX ) | | ( yC != LastSignificantCoeffY ) )
if( lastSubBlock = = 0 && log2TbWidth >= 2 && log2TbHeight >= 2 &&

!transform_skip_flag[ x0 ][y0 ][ cIdx ] && lastScanPos > 0 )

LfnstDcOnly = 0

if( ( lastSubBlock > 0 && log2TbWidth >= 2 && log2TbHeight >= 2 ) | |

( lastScanPos > 7 && ( log2TbWidth = = 2 | | log2TbWidth = = 3 ) &&
log2TbWidth = = log2TbHeight ) )
LfnstZeroOutSigCoeffFlag = 0

<ADD>lastSubBlockX =

DiagScanOrder[ log2TbWidth − log2SbW ][ log2TbHeight − log2SbH ]

[ lastSubBlock ][ 0 ]</ADD>

<ADD>lastSubBlockY =

DiagScanOrder[ log2TbWidth − log2SbW ][ log2TbHeight − log2SbH ]

[ lastSubBlock ][ 1 ]</ADD>

<DELETE>if( ( LastSignificantCoeffX > 15 | | LastSignificantCoeffY > 15 ) &&

cIdx = = 0 )</DELETE>
<ADD> if( ( lastSubBlockX > 3 | | lastSubBlockY > 3 ) && cIdx = = 0 )</ADD>

MtsZeroOutSigCoeffFlag = 0

QState = 0
for( i = lastSubBlock; i >= 0; i− − ) {

startQStateSb = QState

...

7.4.10 Slice data semantics

...

mts_idx specifies which transform kernels are applied along the horizontal and vertical direction of the
associated luma transform block 182s in the current coding unit.
When mts_idx is not present, it is inferred to be equal to 0.
<DELETE>It is a requirement of bitstream conformance that mts_idx shall be equal to 0 if in the
current coding unit at least one coded_sub_block_flag[ xS ][ yS ] in the
residual_coding( x0, y0, log2TbWidth, log2TbHeight, cIdx ) syntax structure is not equal to 0 for cIdx
equal to 0 and xS or yS greater than 3.</DELETE>
When ResetIbcBuf is equal to 1, the following applies:
- For x = 0..IbcBufWidthY − 1 and y = 0..CtbSizeY − 1, the following assignments are made:

| | |
|---|---|
| IbcVirBuf[ 0 ][ x ][ y ] = −1 | (175) |

- The variable ResetIbcBuf is set equal to 0.

When x0 % VSize is equal to 0 and y0 % VSize is equal to 0, the following assignments are

made for x = x0..x0 + VSize − 1 and y = y0..y0 + VSize − 1:

IbcVirBuf[ 0 ][ ( x + ( IbcBufWidthY >> 1 ) ) % IbcBufWidthY ][ y % CtbSizeY ] = −1

As can be seen in the example residual coding syntax of Table 4, the position of the last coded CG in the x-axis is defined as the syntax element lastSubBlockX, and the position of the last coded CG in the y-axis is defined as syntax element lastSubBlockY. Further, the conditional syntax if((LastSignificantCoeffX>15 LastSignificantCoeffY>15) && cIdx==0) is deleted and replaced with the conditional syntax if((lastSubBlockX>3 lastSubBlockY>3) && cIdx==0). Thus, instead of using the last coefficient position, the last coded CG position is used in order to restrict the signaling of the MTS index.

Thus, video coder may, for a transform block 182, traverse through CGs of the transform block 182 according to a scanning order (e.g., a diagonal scan order) starting from the last sub block. The video coder may, for each CG encountered by the video coder, determine whether the CG is a coded CG, such as by determining whether a coded sub-block flag is set for the CG. If the video coder determines that a CG is a coded CG, determine whether the CG is positioned outside of the lowest frequency region 184 of the transform block 182.

For a 64×64 transform block 182 with CGs as 4×4 sub-blocks, the position of CGs in the transform block 182 may range from (0, 0) to (7, 7), and the lowest frequency region 184 of the transform block 182 may span from (0, 0) to (3, 3). Thus, to determine whether a coded CG is positioned outside of the lowest frequency region 184 of the transform block 182, the video coder may determine whether the position of the coded CG in at least one of the x-axis or the y-axis is greater than three. If the video coder determines that the position of the coded CG in at least one of the x-axis or the y-axis is greater than three, the video coder may determine that at least one CG comprising a non-zero transform coefficient is outside of the lowest frequency region 184 of the transform block 182.

In this way, in the example syntax above, in a transform block 182, if the position of the last coded CG in the x-axis (i.e., lastSubBlockX) is greater than 3, or if the position of the last coded CG in the y-axis (i.e., lastSubBlockY) is greater than 3, then video encoder 200 may not signal the MTS index for the transform block 182, and video decoder 300 may infer the value of the MTS index to be zero (i.e., MtsZeroOutSigCoeffFlag is set to zero). On the other hand, if the position of the last coded CG in the x-axis (i.e., lastSubBlockX) is not greater than 3 and if the position of the last coded CG in the y-axis (i.e., lastSubBlockY) is not greater than 3, then the MTS index is signaled (e.g., by a video encoder such as video encoder 200) or is parsed (e.g., by a video decoder such as video decoder 300).

As shown above, in Table 3 and Table 4, the phrase “It is a requirement of bitstream conformance that mts_idx shall be equal to 0 if in the current coding unit at least one coded_sub_block_flag[xS][yS] in the residual coding(x0, y0, log 2TbWidth, log 2TbHeight, cIdx) syntax structure is not equal to 0 for cIdx equal to 0 and xS or yS greater than 3” is deleted from Slice data semantics. As discussed above, instead, the MTS index may be inferred to be a value, such as zero, if the position of the last coded CG in the x-axis is greater than 3, or if the position of the last coded CG in the y-axis is greater than 3.

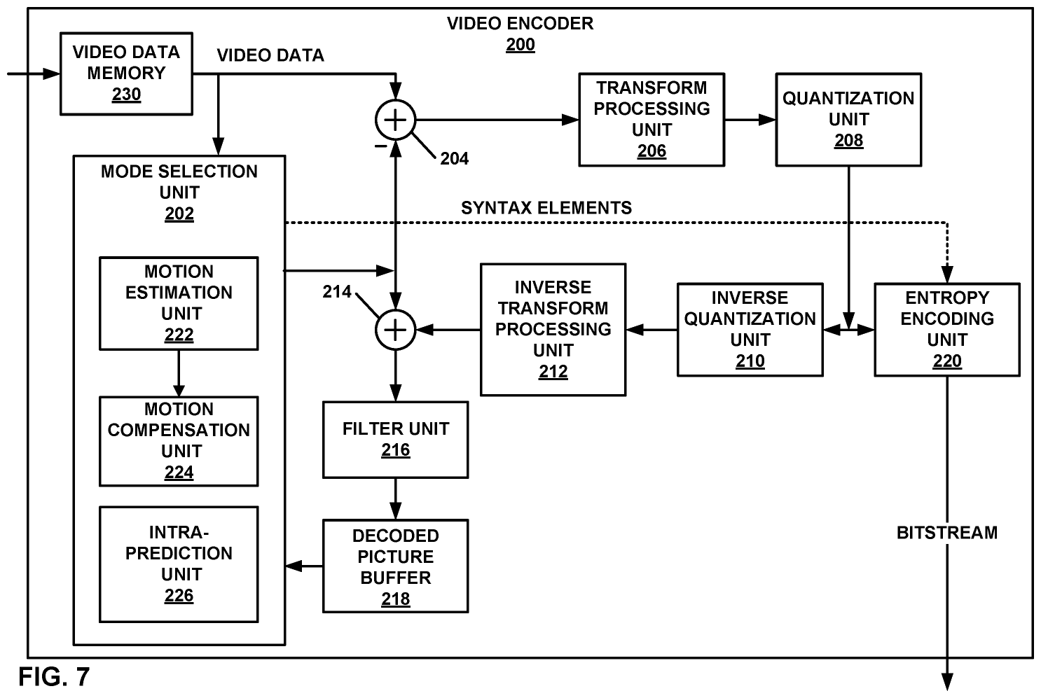

FIG. 7 is a block diagram illustrating an example video encoder 200 that may perform the techniques of this disclosure. FIG. 7 is provided for purposes of explanation and should not be considered limiting of the techniques as broadly exemplified and described in this disclosure. For purposes of explanation, this disclosure describes video encoder 200 according to the techniques of VVC (ITU-T H.266, under development), and HEVC (ITU-T H.265). However, the techniques of this disclosure may be performed by video encoding devices that are configured to other video coding standards.

In the example of FIG. 7, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 7 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

In some examples, transform processing unit 206 may apply multiple transforms of a multiple transform (MT) scheme to a residual block for a current block, including applying multiple transforms of a MT scheme to each of the plurality of residual sub-blocks resulting from the partitioning of a residual block. The MT scheme may define, for example, a primary transform and a secondary transform to be applied to the residual block. Additionally or alternatively, the MT scheme may define a horizontal transform and a vertical transform, such as those shown in FIGS. 4A and 4B as discussed above. In any case, transform processing unit 206 may apply each transform of the MT scheme to the residual block to generate transform coefficients of a transform coefficient block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

In some examples, as part of encoding each transform block (e.g., entropy encoding each quantized transform coefficient block), entropy encoding unit 220 may, for each transform block, scan the transform coefficients of the transform block to determine one or more coded block flags for the transform block as part of reducing the number of bins to be transmitted for signaling the significance map by video encoder 200. For example, entropy encoding unit 220 may, for each coefficient group (e.g., a 4×4 group of transform coefficients) in a transform block, determine a coded sub-block flag for the coefficient group, where the value of the coded sub-block flag for a coefficient group indicates whether the coefficient group includes a non-zero transform coefficient, and may signal (e.g., entropy encode) the coded sub-block flags for the transform block.

Entropy encoding unit 220 may be configured to encode an MTS index (i.e., encode a syntax element indicative of a multiple transform selection) that indicates the multiple transforms (i.e., separable transforms) selected (by, e.g., transform processing unit 206) for a transform block of video data.

In some examples, entropy encoding unit 220 may be configured to determine whether to encode an MTS index (i.e., encode a syntax element indicative of a multiple transform selection) that indicates the multiple transforms (i.e., separable transforms) selected (by, e.g., transform processing unit 206) for a transform block of video data. In some examples, entropy encoding unit 220 may be configured to determine to encode the MTS index only if transform coefficients in the transform block that are outside of a lowest frequent region in the transform block each have a value of zero, where the lowest frequent region in the transform block may be an upper-left portion of the transform block representing the lowest frequency transform coefficients of the transform block.

To determine whether each transform coefficient outside of the lowest frequent region in the transform block has a value of zero, entropy encoding unit 220 may determine whether at least one coefficient group outside of the lowest frequent region in the transform block has a non-zero transform coefficient. For example, entropy encoding unit 220 may scan the transform block coefficient group-by-coefficient group for coefficient groups containing a non-zero transform coefficient.

Because entropy encoding unit 220 has determined, for the transform block, a coded sub-block flag for each coefficient group that indicates whether the coefficient group includes a non-zero transform coefficient, entropy encoding unit 220 may be able to use the coded sub-block flags for the coefficient groups to scan the transform block coefficient group-by-coefficient group for coefficient groups containing a non-zero transform coefficient. For example, entropy encoding unit 220 may, for each coefficient group in the transform block, determine, based on the value of the coded sub-block flag for the coefficient group, whether the coefficient group contains a nonzero coefficient.

Because coded sub-block flags are already determined by, e.g., encoding unit 220 to reduce the number of significance flags signaled by video encoder 200, entropy encoding unit 220 may be able to more efficiently (e.g., use fewer processing cycles to) determine the position of non-zero transform coefficients in the transform block by using the coded sub-block flags to determine whether a coefficient group contains a non-zero transform coefficient. For example, given a 64×64 transform block and 4×4 coefficient groups, entropy encoding unit 220 may potentially scan up to 16 coded sub-block flags to scan the transform block coefficient group-by-coefficient group for coefficient groups containing a non-zero transform coefficient, compared with potentially having to scan up to 4,096 coefficients of the transform block, thereby enabling encoding unit 220 to more efficiently determine the position of non-zero transform coefficients in the transform block.

When entropy encoding unit 220 encounters a coefficient group containing a non-zero transform coefficient (e.g., a coefficient group having an associated coded sub-block flag that indicates the coefficient contains a non-zero transform), entropy encoding unit 220 may determine whether the coefficient group is outside of the lowest frequent region in the transform block. If entropy encoding unit 220 determines that the coefficient group containing a non-zero transform coefficient encountered by entropy encoding unit 220 is outside of the lowest frequent region in the transform block, entropy encoding unit 220 may determine that at least one transform coefficient outside of the lowest frequent region in the transform block has a non-zero value.

the transform block coefficient group-by-coefficient group for coefficient groups containing a non-zero transform coefficient by scanning the coded sub-block flags determined for the transform block to determine, within the transform block, one or more coefficient groups that are each associated with a coded sub-block flag indicating that the coefficient group includes a non-zero transform coefficient

If entropy encoding unit 220 determines that none of the coefficient groups outside of the lowest frequent region in the transform block contains a non-zero transform coefficient, entropy encoding unit 220 may determine that transform coefficients in the transform block that are outside of a lowest frequent region in the transform block each have a value of zero. Entropy encoding unit 220 may encode an MTS index that indicates the multiple transforms selected for the transform block of video data, such as by setting a flag that indicates that coefficients outside of the lowest frequent region in the transform block are zeroed out (i.e., each have a value of zero).

If entropy encoding unit 220 determines that at least one transform coefficient outside of the lowest frequent region in the transform block has a non-zero value, entropy encoding unit 220 may determine not to encode an MTS index that indicates the multiple transforms selected for the transform block of video data. Instead, video decoder 300 may infer (e.g., determine without an explicit syntax element) that the value of the MTS index is a default value, such as zero, and may apply a default transform (e.g., a DCT-2 transform), to the transform block.

Video encoder 200 may output a bitstream that includes the entropy encoded syntax elements needed to reconstruct blocks of a slice or picture. In particular, entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

As will be explained in more details below, video encoder 200 represents an example of a device configured to encode video data including a memory configured to store video data, and one or more processing units implemented in circuitry and configured to determine, for a transform block of video data, whether at least one coefficient group comprising a non-zero transform coefficient of a plurality of coefficient groups comprising transform coefficients is outside of a lowest frequency region of the transform block, determine whether to encode a syntax element indicative of a multiple transform selection (MTS) for the transform block based at least in part on the determination of whether at least one coded coefficient group is outside of the lowest frequency region of the transform block, and encode the video data based at least in part on the determination of whether to code the syntax element indicative of the multiple transform selection.

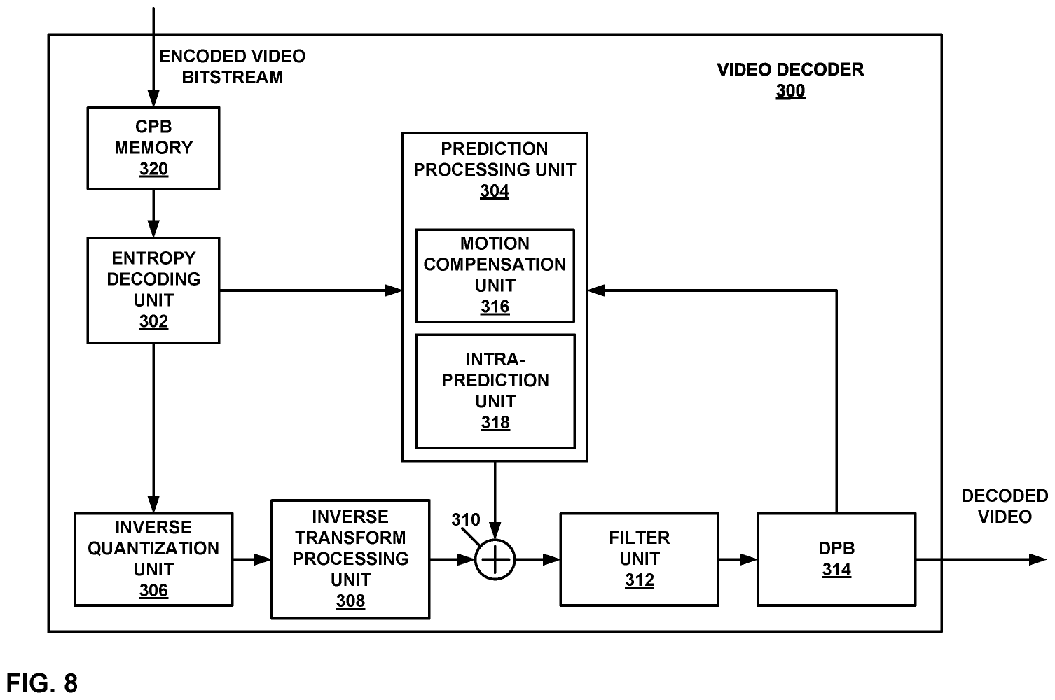

FIG. 8 is a block diagram illustrating an example video decoder 300 that may perform the techniques of this disclosure. FIG. 8 is provided for purposes of explanation and is not limiting on the techniques as broadly exemplified and described in this disclosure. For purposes of explanation, this disclosure describes video decoder 300 according to the techniques of VVC (ITU-T H.266, under development), and HEVC (ITU-T H.265). However, the techniques of this disclosure may be performed by video coding devices that are configured to other video coding standards.

In the example of FIG. 8, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 8 are illustrated to assist with understanding the operations performed by video decoder 300. The units may be implemented as fixed-function circuits, programmable circuits, or a combination thereof. Similar to FIG. 7, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

In some examples, as part of decoding each transform block (e.g., entropy decoding each transform coefficient block), entropy decoding unit 302 may decode a coded sub-block flag for each coefficient group (e.g., a 4×4 group of transform coefficients) in the transform block, where the value of the coded sub-block flag for a coefficient group indicates whether the coefficient group includes a non-zero transform coefficient.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

In some examples inverse transform processing unit 308 may be configured to apply one or more inverse multiple transforms (e.g., using MTS techniques) to a transform block of video data. As explained above video encoder 200 may encode a syntax element that indicates the multiple transforms selected for the transform block of video data only if there are no non-zero transform coefficients in the transform block. As such, as will be explained in more detail below, in some examples, inverse transform processing unit 308 may be configured to determine whether video encoder 200 should decode the MTS index (i.e., decode a syntax element indicative of a multiple transform selection) signaled in the bitstream that indicates the multiple transforms (i.e., separable transforms) selected by video encoder 200 for a transform block of video data.

In some examples, inverse transform processing unit 308 may be configured to decode and use the MTS index signaled in the bitstream only if transform coefficients in the transform block that are outside of a lowest frequent region in the transform block each have a value of zero, where the lowest frequent region in the transform block may be an upper-left portion of the transform block representing the lowest frequency transform coefficients of the transform block.

To determine whether each transform coefficient outside of the lowest frequent region in the transform block has a value of zero, inverse transform processing unit 308 may determine whether at least one coefficient group outside of the lowest frequent region in the transform block has a non-zero transform coefficient. For example, inverse transform processing unit 308 may scan the transform block coefficient group-by-coefficient group for coefficient groups containing a non-zero transform coefficient.

Because entropy decoding unit 302 has already decoded, for the transform block, a coded sub-block flag for each coefficient group that indicates whether the coefficient group includes a non-zero transform coefficient, inverse transform processing unit 308 may be able to use the coded sub-block flags for the coefficient groups to scan the transform block coefficient group-by-coefficient group for coefficient groups containing a non-zero transform coefficient. For example, inverse transform processing unit 308 may, for each coefficient group in the transform block, determine, based on the value of the coded sub-block flag for the coefficient group, whether the coefficient group contains a nonzero coefficient.

Because coded sub-block flags are already decoded by entropy decoding unit 302, inverse transform processing unit 308 may be able to more efficiently (e.g., use fewer processing cycles to) determine the position of non-zero transform coefficients in the transform block by using the coded sub-block flags to determine whether a coefficient group contains a non-zero transform coefficient. For example, given a 64×64 transform block and 4×4 coefficient groups, inverse transform processing unit 308 may potentially scan up to 16 coded sub-block flags to scan the transform block coefficient group-by-coefficient group for coefficient groups containing a non-zero transform coefficient, compared with potentially having to scan up to 4,096 coefficients of the transform block, thereby enabling inverse transform processing unit 308 to more efficiently determine the position of non-zero transform coefficients in the transform block.

When inverse transform processing unit 308 encounters a coefficient group containing a non-zero transform coefficient (e.g., a coefficient group having an associated coded sub-block flag that indicates the coefficient contains a non-zero transform), inverse transform processing unit 308 may determine whether the coefficient group is outside of the lowest frequent region in the transform block. If inverse transform processing unit 308 determines that the coefficient group containing a non-zero transform coefficient encountered by inverse transform processing unit 308 is outside of the lowest frequent region in the transform block, inverse transform processing unit 308 may determine that at least one transform coefficient outside of the lowest frequent region in the transform block has a non-zero value.

If inverse transform processing unit 308 determines that none of the coefficient groups outside of the lowest frequent region in the transform block contains a non-zero transform coefficient, inverse transform processing unit 308 may determine that transform coefficients in the transform block that are outside of a lowest frequent region in the transform block each have a value of zero. Inverse transform processing unit 308 may therefore apply the inverse multiple transforms of the multiple transforms indicated by the syntax element to the transform block of video data.

If inverse transform processing unit 308 determines that at least one transform coefficient outside of the lowest frequent region in the transform block has a non-zero value, inverse transform processing unit 308 may infer (e.g., determine without an explicit syntax element) that the value of the MTS index for the trans form block is a default value, such as zero, and may apply a default transform (e.g., a DCT-2 transform), to the transform block of video data. Inverse transform processing unit 308 may infer the value of the MTS index for the transform block even if the bitstream received from video encoder 200 signals the MTS index for the transform block, thereby refraining from decoding the MTS index for the transform block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 7).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 7). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to determine, for a transform block of video data, whether at least one coefficient group comprising a non-zero transform coefficient of a plurality of coefficient groups comprising transform coefficients is outside of a lowest frequency region of the transform block, determine whether to decode a syntax element indicative of a multiple transform selection (MTS) for the transform block based at least in part on the determination of whether at least one coded coefficient group is outside of the lowest frequency region of the transform block, and decode the video data based at least in part on the determination of whether to code the syntax element indicative of the multiple transform selection.

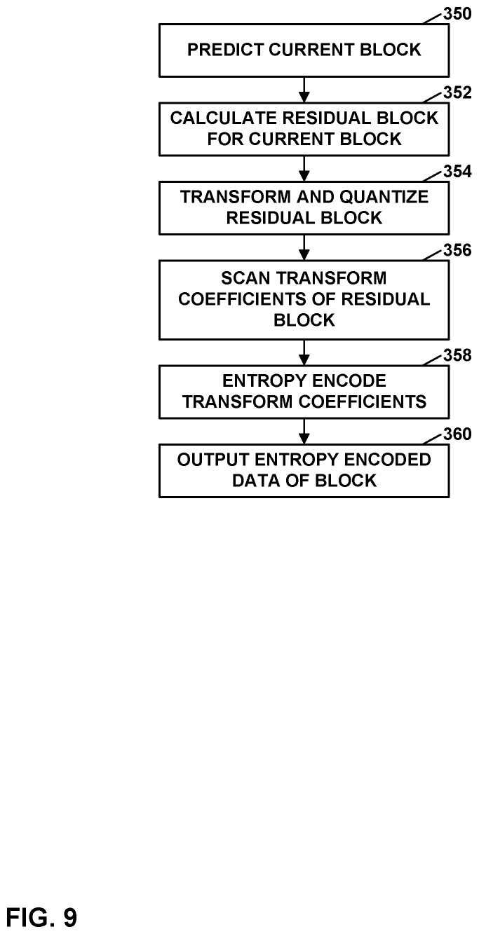

FIG. 9 is a flowchart illustrating an example method for encoding a current block in accordance with the techniques of this disclosure. The current block may comprise a current CU. Although described with respect to video encoder 200 (FIGS. 1 and 7), it should be understood that other devices may be configured to perform a method similar to that of FIG. 9.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, unencoded block and the prediction block for the current block. Video encoder 200 may then transform the residual block and quantize transform coefficients of the residual block (354). For example, video encoder 200 may select a multiple transform for the residual block and signal the selected multiple transform via an MTS index. Next, video encoder 200 may scan the quantized transform coefficients of the residual block (356). During the scan, video encoder 200 may determine whether at least one coefficient group comprising a non-zero transform coefficient of a plurality of coefficient groups comprising transform coefficients is outside of a lowest frequency region of the residual block. During the scan, or following the scan, video encoder 200 may entropy encode the transform coefficients (358). For example, video encoder 200 may determine whether to encode a syntax element indicative of a multiple transform selection for the residual block based at least in part on the determination of whether at least one coded coefficient group is outside of the lowest frequency region of the transform unit and may encode the video data based at least in part on the determination of whether to encode the syntax element indicative of the multiple transform selection. Video encoder 200 may encode the transform coefficients using CAVLC or CABAC. Video encoder 200 may then output the entropy encoded data of the block (360).

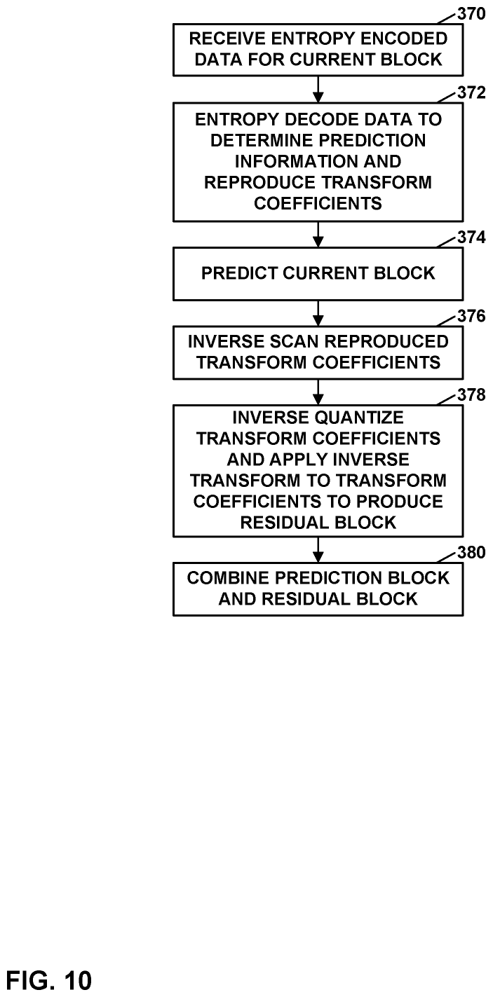

FIG. 10 is a flowchart illustrating an example method for decoding a current block of video data in accordance with the techniques of this disclosure. The current block may comprise a current CU. Although described with respect to video decoder 300 (FIGS. 1 and 8, it should be understood that other devices may be configured to perform a method similar to that of FIG. 10.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). For example, video decoder 300 may determine whether at least one coefficient group comprising a non-zero transform coefficient of a plurality of coefficient groups comprising transform coefficients is outside of a lowest frequency region of the residual block, and may determine whether to decode a syntax element indicative of a multiple transform selection for the residual block based at least in part on the determination of whether at least one coded coefficient group is outside of the lowest frequency region of the transform unit. If video decoder 300 determines that at least one coefficient group comprising a non-zero transform coefficient of a plurality of coefficient groups comprising transform coefficients is outside of a lowest frequency region of the residual block, video decoder 300 may not decode the syntax element indicative of a multiple transform selection for the residual block and may instead infer a value of the syntax element indicative of a multiple transform selection for the residual block.

Video decoder 300 may predict the current block (374), e.g., using an intra- or inter-prediction mode as indicated by the prediction information for the current block, to calculate a prediction block for the current block. Video decoder 300 may then inverse scan the reproduced transform coefficients (376), to create a block of quantized transform coefficients. Video decoder 300 may then inverse quantize the transform coefficients and apply an inverse transform, such as an inverse of the multiple transform inferred by the video decoder 300, to the transform coefficients to produce a residual block (378). Video decoder 300 may ultimately decode the current block by combining the prediction block and the residual block (380).

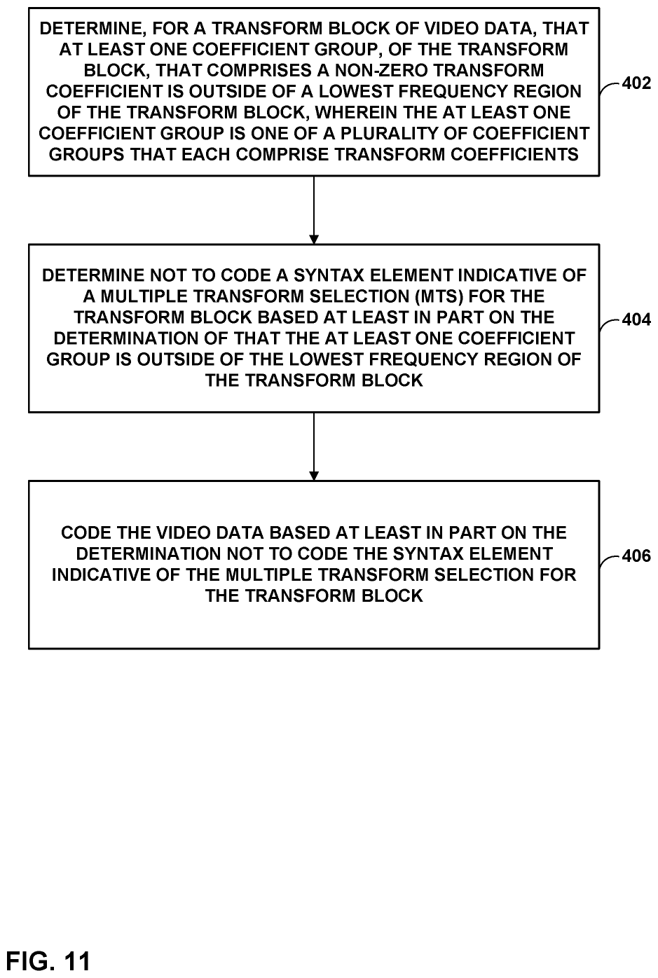

FIG. 11 is a flowchart illustrating an example method for determining whether to code a multiple transform selection. As shown in FIG. 11, a video coder, such as video encoder 200 or video decoder 300, may determine, for a transform block of video data, that at least one coefficient group, of the transform block, that comprises a non-zero transform coefficient is outside of a lowest frequency region of the transform block, wherein the at least one coefficient group is one of a plurality of coefficient groups that each comprise transform coefficients (402). The video coder may determine not to code a syntax element indicative of a multiple transform selection (MTS) for the transform block based at least in part on the determination of that the at least one coefficient group is outside of the lowest frequency region of the transform block (404). The video coder may determine to code the video data based at least in part on the determination not to code the syntax element indicative of the multiple transform selection for the transform block (406).

In some examples, to determine that at least one coefficient group, of the coefficient block, that comprises a non-zero transform coefficient is outside of the lowest frequency region of the transform block, the video coder may determine, for a coefficient group of the plurality of coefficient groups comprising transform coefficients, that a coded sub-block flag for the coefficient group is set, in response to determining that the coded sub-block flag for the coefficient group is set, determine that a position of the coefficient group is greater than 3 in at least one of an x-axis or a y-axis, and in response to determining that the position of the coefficient group is greater than 3 in at least one of the x-axis or the y-axis, determine, for the transform block of the video data, that at least one coefficient group, of the transform block, that comprises a non-zero transform coefficient is outside of the lowest frequency region of the transform block.

In some examples, the video coder may further determine, for a second transform block of video data, that no coefficient group, of a second plurality of coefficient groups of the second transform block, that comprises a non-zero transform coefficient is outside of a lowest frequency region of the second transform block, wherein the second plurality of coefficient groups each comprise a plurality of transform coefficients, determine to code a second syntax element indicative of the MTS for the second transform block based at least in part on the determination of that no coefficient group is outside of the lowest frequency region of the second transform block, and code the video data based at least in part on the determination to code the second syntax element indicative of the MTS for the second transform block.

In some examples, to determine that no coefficient group that comprises a non-zero coefficient group is outside of the lowest frequency region of the second transform block, the video coder may further determine, from the plurality of coefficient groups, of the second transform block, one or more coefficient groups for which a coded sub-block flag is set for each of the one or more coefficient groups, determine that a position of each of the one or more coefficient groups is not greater than 3 in both an x-axis and a y-axis, and in response to determining that the position of each of the one or more coefficient groups is not greater than 3 in both the x-axis and the y-axis, determine, for the second transform block of the video data, that no coefficient group, of the second plurality of coefficient groups of the second transform block, that comprises a non-zero transform coefficient is outside of a lowest frequency region of the second transform block.

In some examples, the lowest frequency region of the transform block comprises an upper-left region of the transform block. In some examples, the transform block comprises a 32×32 block, the upper-left region of the transform block comprises an upper-left 16×16 region of the 32×32 block, and each of the plurality of coefficient groups comprises a 4×4 block of coefficients associated with the transform block. In some examples, the syntax element indicative of the multiple transform selection for the transform block is indicative of a MTS index that specifies a separable transform for the transform block.

In some examples, the video coder comprises a video encoder 200. To determine not to code the syntax element, the video encoder 200 may determine not to encode the syntax element, and to code the video data based on the determination not to code the syntax element, the video encoder 200 is configured to encode the video data without encoding the syntax element.

In some examples, the video coder comprises a video decoder 300. To determine not to code the syntax element, the video decoder 300 is configured to determine not to decode the syntax element. To code the video data based on the determination not to code the syntax element, the video decoder 300 is configured to decode the video data without decoding the syntax element. In some examples, to decode the video data, the video decoder 300 is configured to, in response to determining not to decode the syntax element, infer a value of the syntax element.

In some examples, the video coder further comprises a display configured to display decoded video data. In some examples, the video coder comprises one or more of a camera, a computer, a mobile device, a broadcast receiver device, or a set-top box. In some examples, the device comprises at least one of: an integrated circuit, a microprocessor, or a wireless communication device.

In some examples, to determine that at least one coefficient group comprising a non-zero transform coefficient of the plurality of coefficient groups comprising transform coefficients is outside of the lowest frequency region of the transform block, the video coder may determine, for a coefficient group of the plurality of coefficient groups comprising transform coefficients, whether a coded sub-block flag for the coefficient group is set, in response to determining that the coded sub-block flag for the coefficient group is set, determine whether a position of the coefficient group is greater than 3 in at least one of an x-axis or a y-axis, and in response to determining that the position of the coefficient group is greater than 3 in at least one of the x-axis or the y-axis, determine, for the transform block of the video data, that at least one coefficient group comprising a non-zero transform coefficient of the plurality of coefficient groups comprising transform coefficients is outside of the lowest frequency region of the transform block.

In some examples, to determine, for the transform block of the video data, whether at least one coefficient group comprising a non-zero transform coefficient of the plurality of coefficient groups comprising transform coefficients is outside of the lowest frequency region of the transform block the video coder may determine that none of the coefficient groups comprising transform coefficients is outside of the lowest frequency region of the transform block. In some examples, to determine whether to code the syntax element indicative of the multiple transform selection for the transform block based at least in part on the determination of whether at least one coded coefficient group is outside of the lowest frequency region of the transform block the video coder may in response to determining that none of the coefficient groups comprising transform coefficients is outside of the lowest frequency region of the transform block, determine to code the syntax element indicative of the multiple transform selection for the transform block. In some examples, to code the video data based at least in part on the determination of whether to code the syntax element indicative of the multiple transform selection, the video coder may code the video data that include the syntax element indicative of the multiple transform selection for the transform block.

In some examples, to determine that none of the coefficient groups comprising transform coefficients is outside of the lowest frequency region of the transform block, the video coder may determine, from the plurality of coefficient groups comprising transform coefficients, one or more coefficient groups for which a coded sub-block flag is set for each of the one or more coefficient groups, determine that a position of each of the one or more coefficient groups is greater than 3 in at least one of an x-axis or a y-axis, and in response to determining that the position of each of the one or more coefficient groups is not greater than 3 in both the x-axis and the y-axis, determine, for the transform block of the video data, that none of the coefficient groups comprising transform coefficients is outside of the lowest frequency region of the transform block

In some examples, the lowest frequency region of the transform block comprises an upper-left region of the transform block. In some examples, the transform block comprises a 32×32 block, the upper-left region of the transform block comprises an upper-left 16×16 region of the 32×32 block, and each of the plurality of coefficient groups comprises a 4×4 block of coefficients associated with the transform block.

In some examples, the syntax element indicative of the multiple transform selection for the transform block is indicative of a MTS index that specifies a separable transform for the transform block.

In some examples, the video coder is a video decoder 300, wherein to determine whether to code the syntax element, video decoder 300 is configured to determine whether to decode the syntax element, and wherein to code the video data, video decoder 300 is configured to decode the video data. In some examples, to decode the video data, video decoder 300 may, in response to determining not to decode the syntax element, infer a value of the syntax element.

In some examples, video decoder 300 further includes a display configured to display decoded video data. In some examples, video decoder 300 comprises one or more of a camera, a computer, a mobile device, a broadcast receiver device, or a set-top box. In some examples, video decoder 300 comprises at least one of: an integrated circuit, a microprocessor, or a wireless communication device.

This disclosure contains the following aspects:

Aspect 1: A method of coding video data includes determining, for a transform block of video data, that at least one coefficient group, of the transform block, that comprises a non-zero transform coefficient is outside of a lowest frequency region of the transform block, wherein the at least one coefficient group is one of a plurality of coefficient groups that each comprise transform coefficients; determining not to code a syntax element indicative of a multiple transform selection (MTS) for the transform block based at least in part on the determination of that the at least one coefficient group is outside of the lowest frequency region of the transform block; and coding the video data based at least in part on the determination not to code the syntax element indicative of the multiple transform selection for the transform block.

Aspect 2: The method of aspect 1, wherein determining that at least one coefficient group, of the transform block, that comprises a non-zero transform coefficient is outside of the lowest frequency region of the transform block further comprises: determining, for a coefficient group of the plurality of coefficient groups comprising transform coefficients, that a coded sub-block flag for the coefficient group is set; in response to determining that the coded sub-block flag for the coefficient group is set, determining that a position of the coefficient group is greater than 3 in at least one of an x-axis or a y-axis; and in response to determining that the position of the coefficient group is greater than 3 in at least one of the x-axis or the y-axis, determining, for the transform block of the video data, that at least one coefficient group, of the transform block, that comprises a non-zero transform coefficient is outside of the lowest frequency region of the transform block.

Aspect 3: The method of aspect 1, further includes determining, for a second transform block of video data, that no coefficient group, of a second plurality of coefficient groups of the second transform block, that comprises a non-zero transform coefficient is outside of a lowest frequency region of the second transform block, wherein the second plurality of coefficient groups each comprise a plurality of transform coefficients; determining to code a second syntax element indicative of the MTS for the second transform block based at least in part on the determination of that no coefficient group is outside of the lowest frequency region of the second transform block; and coding the video data based at least in part on the determination to code the second syntax element indicative of the MTS for the second transform block.

Aspect 4: The method of aspect 3, wherein determining that no coefficient group that comprises a non-zero coefficient group is outside of the lowest frequency region of the second transform block comprises: determining, from the plurality of coefficient groups, of the second transform block, one or more coefficient groups for which a coded sub-block flag is set for each of the one or more coefficient groups; determining that a position of each of the one or more coefficient groups is not greater than 3 in both an x-axis and a y-axis; and in response to determining that the position of each of the one or more coefficient groups is not greater than 3 in both the x-axis and the y-axis, determining, for the second transform block of the video data, that no coefficient group, of the second plurality of coefficient groups of the second transform block, that comprises a non-zero transform coefficient is outside of a lowest frequency region of the second transform block.

Aspect 5: The method of any of aspects 1-4, wherein the lowest frequency region of the transform block comprises an upper-left region of the transform block.

Aspect 6: The method of aspect 5, wherein: the transform block comprises a 32×32 block; the upper-left region of the transform block comprises an upper-left 16×16 region of the 32×32 block; and each of the plurality of coefficient groups comprises a 4×4 block of coefficients associated with the transform block.

Aspect 7: The method of any of aspects 1-6, wherein: the syntax element indicative of the multiple transform selection for the transform block is indicative of a MTS index that specifies a separable transform for the transform block.

Aspect 8: The method of any of aspects 1 and 2, wherein: determining not to code the syntax element comprises determining not to encode the syntax element; and coding the video data based on the determination not to code the syntax element comprises encoding the video data without encoding the syntax element.

Aspect 9: The method of any of aspects 1 and 2, wherein: determining not to code the syntax element comprises determining not to decode the syntax element; and coding the video data based on the determination not to code the syntax element comprises decoding the video data without decoding the syntax element.

Aspect 10: The method of aspect 9, wherein decoding the video data further comprises: in response to determining not to decode the syntax element, inferring a value of the syntax element.

Aspect 11: A device for coding video data includes a memory; and a processor implemented in circuitry and configured to: determine, for a transform block of video data, that at least one coefficient group, of the transform block, that comprises a non-zero transform coefficient is outside of a lowest frequency region of the transform block, wherein the at least one coefficient group is one of a plurality of coefficient groups that each comprise transform coefficients; determine not to code a syntax element indicative of a multiple transform selection (MTS) for the transform block based at least in part on the determination of that the at least one coefficient group is outside of the lowest frequency region of the transform block; and code the video data based at least in part on the determination not to code the syntax element indicative of the multiple transform selection for the transform block.

Aspect 12: The device of aspect 11, wherein to determine that at least one coefficient group, of the coefficient block, that comprises a non-zero transform coefficient is outside of the lowest frequency region of the transform block, the processor is further configured to: determine, for a coefficient group of the plurality of coefficient groups comprising transform coefficients, that a coded sub-block flag for the coefficient group is set; in response to determining that the coded sub-block flag for the coefficient group is set, determine that a position of the coefficient group is greater than 3 in at least one of an x-axis or a y-axis; and in response to determining that the position of the coefficient group is greater than 3 in at least one of the x-axis or the y-axis, determine, for the transform block of the video data, that at least one coefficient group, of the transform block, that comprises a non-zero transform coefficient is outside of the lowest frequency region of the transform block.

Aspect 13: The device of aspect 11, wherein the processor is further configured to: determine, for a second transform block of video data, that no coefficient group, of a second plurality of coefficient groups of the second transform block, that comprises a non-zero transform coefficient is outside of a lowest frequency region of the second transform block, wherein the second plurality of coefficient groups each comprise a plurality of transform coefficients; determine to code a second syntax element indicative of the MTS for the second transform block based at least in part on the determination of that no coefficient group is outside of the lowest frequency region of the second transform block; and code the video data based at least in part on the determination to code the second syntax element indicative of the MTS for the second transform block.

Aspect 14: The device of aspect 13, wherein to determine that no coefficient group that comprises a non-zero coefficient group is outside of the lowest frequency region of the second transform block, the processor is further configured to: determine, from the plurality of coefficient groups, of the second transform block, one or more coefficient groups for which a coded sub-block flag is set for each of the one or more coefficient groups; determine that a position of each of the one or more coefficient groups is not greater than 3 in both an x-axis and a y-axis; and in response to determining that the position of each of the one or more coefficient groups is not greater than 3 in both the x-axis and the y-axis, determine, for the second transform block of the video data, that no coefficient group, of the second plurality of coefficient groups of the second transform block, that comprises a non-zero transform coefficient is outside of a lowest frequency region of the second transform block.

Aspect 15: The device of any of aspects 11-14, wherein the lowest frequency region of the transform block comprises an upper-left region of the transform block.

Aspect 16: The device of aspect 15, wherein: the transform block comprises a 32×32 block; the upper-left region of the transform block comprises an upper-left 16×16 region of the 32×32 block; and each of the plurality of coefficient groups comprises a 4×4 block of coefficients associated with the transform block.

Aspect 17: The device of any of aspects 11-16, wherein: the syntax element indicative of the multiple transform selection for the transform block is indicative of a MTS index that specifies a separable transform for the transform block.

Aspect 18: The device of any of aspects 11 and 12, wherein: the device comprises a video encoder to determine not to code the syntax element, the processor is configured to determine not to encode the syntax element; and to code the video data based on the determination not to code the syntax element, the processor is configured to encode the video data without encoding the syntax element.

Aspect 19: The device of any of aspects 11 and 12, wherein: the device comprises a video decoder to determine not to code the syntax element, the processor is configured to determine not to decode the syntax element; and to code the video data based on the determination not to code the syntax element, the processor is configured to decode the video data without decoding the syntax element.

Aspect 20: The device of aspect 19, wherein to decode the video data, the processor is configured to: in response to determining not to decode the syntax element, infer a value of the syntax element.

Aspect 21: The device of any of aspects 11-20, further comprising a display configured to display decoded video data.

Aspect 22: The device of any of aspects 11-21, wherein the device comprises one or more of a camera, a computer, a mobile device, a broadcast receiver device, or a set-top box.

Aspect 23: The device of any of aspects 11-22, wherein the device comprises at least one of: an integrated circuit; a microprocessor; or a wireless communication device.

Aspect 24: A device for coding data includes means for determining, for a transform block of video data, that at least one coefficient group, of the transform block, that comprises a non-zero transform coefficient is outside of a lowest frequency region of the transform block, wherein the at least one coefficient group is one of a plurality of coefficient groups that each comprise transform coefficients; means for determining not to code a syntax element indicative of a multiple transform selection (MTS) for the transform block based at least in part on the determination of that the at least one coefficient group is outside of the lowest frequency region of the transform block; and means for coding the video data based at least in part on the determination not to code the syntax element indicative of the multiple transform selection for the transform block.

Aspect 25: The device of aspect 24, wherein the means for determining that at least one coefficient group, of the transform block, that comprises a non-zero transform coefficient is outside of the lowest frequency region of the transform block further comprises: means for determining, for a coefficient group of the plurality of coefficient groups comprising transform coefficients, that a coded sub-block flag for the coefficient group is set; means for, in response to determining that the coded sub-block flag for the coefficient group is set, determining that a position of the coefficient group is greater than 3 in at least one of an x-axis or a y-axis; and means for, in response to determining that the position of the coefficient group is greater than 3 in at least one of the x-axis or the y-axis, determining, for the transform block of the video data, that at least one coefficient group, of the transform block, that comprises a non-zero transform coefficient is outside of the lowest frequency region of the transform block.

Aspect 26: The device of aspect 24, further includes means for determining, for a second transform block of video data, that no coefficient group, of a second plurality of coefficient groups of the second transform block, that comprises a non-zero transform coefficient is outside of a lowest frequency region of the second transform block, wherein the second plurality of coefficient groups each comprise a plurality of transform coefficients; means for determining to code a second syntax element indicative of the MTS for the second transform block based at least in part on the determination of that no coefficient group is outside of the lowest frequency region of the second transform block; and means for coding the video data based at least in part on the determination to code the second syntax element indicative of the MTS for the second transform block.

Aspect 27: The device of aspect 26, wherein the means for determining that no coefficient group that comprises a non-zero coefficient group is outside of the lowest frequency region of the second transform block comprises: means for determining, from the plurality of coefficient groups, of the second transform block, one or more coefficient groups for which a coded sub-block flag is set for each of the one or more coefficient groups; means for determining that a position of each of the one or more coefficient groups is not greater than 3 in both an x-axis and a y-axis; and means for, in response to determining that the position of each of the one or more coefficient groups is not greater than 3 in both the x-axis and the y-axis, determining, for the second transform block of the video data, that no coefficient group, of the second plurality of coefficient groups of the second transform block, that comprises a non-zero transform coefficient is outside of a lowest frequency region of the second transform block.

Aspect 28: The device of any of aspects 24 and 25, wherein: the means for determining not to code the syntax element comprises means for determining not to decode the syntax element; and the means for coding the video data based on the determination not to code the syntax element comprises means for decoding the video data without decoding the syntax element.

Aspect 29: The device of aspect 28, wherein the means for decoding the video data further comprises: means for, in response to determining not to decode the syntax element, inferring a value of the syntax element.

Aspect 30: A computer-readable storage medium having stored thereon instructions that, when executed, cause one or more processors to: determine, for a transform block of video data, that at least one coefficient group, of the transform block, that comprises a non-zero transform coefficient is outside of a lowest frequency region of the transform block, wherein the at least one coefficient group is one of a plurality of coefficient groups that each comprise transform coefficients; determine not to code a syntax element indicative of a multiple transform selection (MTS) for the transform block based at least in part on the determination of that the at least one coefficient group is outside of the lowest frequency region of the transform block; and code the video data based at least in part on the determination not to code the syntax element indicative of the multiple transform selection for the transform block.

Aspect 31: A method of coding video data, the method comprising: determining a position of a last coded coefficient group in at least one of: an x-axis or an y-axis; based on the position of the last coded coefficient group in at least one of: the x-axis or the y-axis, determining whether to signal a multiple transform selection (MTS) index or whether to parse the MTS index; and coding the video data based at least in part on the determination of whether to signal the MTS index or whether to parse the MTS index.

Aspect 32: The method of aspect 31, wherein based on the position of the last coded coefficient group in at least one of: the x-axis or the y-axis, determining whether to signal the MTS index or whether to parse the MTS index further comprises: based on the position of the last coded coefficient group in at least one of: the x-axis or the y-axis being greater than 3, determining not to signal the MTS index or determining not to parse the MTS index.

Aspect 33: The method of aspect 32, wherein determining not to signal the MTS index or determining not to parse the MTS index further comprises inferring a value for the MTS index.

Aspect 34: The method of any of aspects 31-33, wherein inferring the value for the MTS index comprises inferring the value for the MTS index to be 0.

Aspect 35: The method of any of aspects 31-34, wherein inferring the value for the MTX index comprises inferring the value for the MTS index that corresponds to a DCT-2 transform.

Aspect 36: The method of any of aspects 31-35, wherein based on the position of the last coded coefficient group in at least one of: the x-axis or the y-axis, determining whether to signal the MTS index or whether to parse the MTS index further comprises: based on the position of the last coded coefficient group in both the x-axis and the y-axis being no greater than 3, determining to signal the MTS index and/or determining to parse the MTS index.

Aspect 37: The method of any of aspects 31-36, wherein the MTS index specifies a separable transform being used to code the video data.

Aspect 38: The method of any of aspects 31-37, wherein the MTS index specifies one or more transform kernels are applied along a horizontal direction and a vertical direction of one or more associated luma transform blocks in a current coding unit of the video data.

Aspect 39: The method of any of aspects 31-38, wherein coding comprises decoding.

Aspect 40: The method of any of aspects 31-38, wherein coding comprises encoding.

Aspect 41: A device for coding video data, the device comprising one or more means for performing the method of any of aspects 31-30.

Aspect 42: The device of aspect 41, wherein the one or more means comprise one or more processors implemented in circuitry.

Aspect 43: The device of any of aspects 41 and 42, further comprising a memory to store the video data.

Aspect 44: The device of any of aspects 41-43, further comprising a display configured to display decoded video data.

Aspect 45: The device of any of aspects 41-44, wherein the device comprises one or more of a camera, a computer, a mobile device, a broadcast receiver device, or a set-top box.

Aspect 46: The device of any of aspects 41-45, wherein the device comprises a video decoder.

Aspect 47: The device of any of aspects 41-46, wherein the device comprises a video encoder.

Aspect 48: A computer-readable storage medium having stored thereon instructions that, when executed, cause one or more processors to perform the method of any of aspects 30-40.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
determining, for a transform block of video data, that at least one coefficient group, of the transform block, that comprises a non-zero transform coefficient is outside of a lowest frequency region of the transform block, wherein the at least one coefficient group is one of a plurality of coefficient groups that each comprise transform coefficients;
determining not to code a syntax element indicative of a multiple transform selection (MTS) for the transform block based at least in part on the determination of that the at least one coefficient group is outside of the lowest frequency region of the transform block; and
coding the video data based at least in part on the determination not to code the syntax element indicative of the multiple transform selection for the transform block.

2. The method of claim 1, wherein determining that at least one coefficient group, of the transform block, that comprises a non-zero transform coefficient is outside of the lowest frequency region of the transform block further comprises:
determining, for a coefficient group of the plurality of coefficient groups comprising transform coefficients, that a coded sub-block flag for the coefficient group is set;
in response to determining that the coded sub-block flag for the coefficient group is set, determining that a position of the coefficient group is greater than 3 in at least one of an x-axis or a y-axis; and
in response to determining that the position of the coefficient group is greater than 3 in at least one of the x-axis or the y-axis, determining, for the transform block of the video data, that at least one coefficient group, of the transform block, that comprises a non-zero transform coefficient is outside of the lowest frequency region of the transform block.

3. The method of claim 1, further comprising:
determining, for a second transform block of video data, that no coefficient group, of a second plurality of coefficient groups of the second transform block, that comprises a non-zero transform coefficient is outside of a lowest frequency region of the second transform block, wherein the second plurality of coefficient groups each comprise a plurality of transform coefficients;
determining to code a second syntax element indicative of the MTS for the second transform block based at least in part on the determination of that no coefficient group is outside of the lowest frequency region of the second transform block; and
coding the video data based at least in part on the determination to code the second syntax element indicative of the MTS for the second transform block.

4. The method of claim 3, wherein determining that no coefficient group that comprises a non-zero coefficient group is outside of the lowest frequency region of the second transform block comprises:
determining, from the plurality of coefficient groups, of the second transform block, one or more coefficient groups for which a coded sub-block flag is set for each of the one or more coefficient groups;
determining that a position of each of the one or more coefficient groups is not greater than 3 in both an x-axis and a y-axis; and
in response to determining that the position of each of the one or more coefficient groups is not greater than 3 in both the x-axis and the y-axis, determining, for the second transform block of the video data, that no coefficient group, of the second plurality of coefficient groups of the second transform block, that comprises a non-zero transform coefficient is outside of a lowest frequency region of the second transform block.

5. The method of claim 1, wherein the lowest frequency region of the transform block comprises an upper-left region of the transform block.

6. The method of claim 5, wherein:
the transform block comprises a 32×32 block;
the upper-left region of the transform block comprises an upper-left 16×16 region of the 32×32 block; and
each of the plurality of coefficient groups comprises a 4×4 block of coefficients associated with the transform block.

7. The method of claim 1, wherein:
the syntax element indicative of the multiple transform selection for the transform block is indicative of a MTS index that specifies a separable transform for the transform block.

8. The method of claim 1, wherein:
determining not to code the syntax element comprises determining not to encode the syntax element; and
coding the video data based on the determination not to code the syntax element comprises encoding the video data without encoding the syntax element.

9. The method of claim 1, wherein:
determining not to code the syntax element comprises determining not to decode the syntax element; and
coding the video data based on the determination not to code the syntax element comprises decoding the video data without decoding the syntax element.

10. The method of claim 9, wherein decoding the video data further comprises:
in response to determining not to decode the syntax element, inferring a value of the syntax element.

11. A device for coding video data, the device comprising:
a memory; and
a processor implemented in circuitry and configured to:
determine, for a transform block of video data, that at least one coefficient group, of the transform block, that comprises a non-zero transform coefficient is outside of a lowest frequency region of the transform block, wherein the at least one coefficient group is one of a plurality of coefficient groups that each comprise transform coefficients;
determine not to code a syntax element indicative of a multiple transform selection (MTS) for the transform block based at least in part on the determination of that the at least one coefficient group is outside of the lowest frequency region of the transform block; and
code the video data based at least in part on the determination not to code the syntax element indicative of the multiple transform selection for the transform block.

12. The device of claim 11, wherein to determine that at least one coefficient group, of the transform block, that comprises a non-zero transform coefficient is outside of the lowest frequency region of the transform block, the processor is further configured to:
determine, for a coefficient group of the plurality of coefficient groups comprising transform coefficients, that a coded sub-block flag for the coefficient group is set;
in response to determining that the coded sub-block flag for the coefficient group is set, determine that a position of the coefficient group is greater than 3 in at least one of an x-axis or a y-axis; and
in response to determining that the position of the coefficient group is greater than 3 in at least one of the x-axis or the y-axis, determine, for the transform block of the video data, that at least one coefficient group, of the transform block, that comprises a non-zero transform coefficient is outside of the lowest frequency region of the transform block.

13. The device of claim 11, wherein the processor is further configured to:
determine, for a second transform block of video data, that no coefficient group, of a second plurality of coefficient groups of the second transform block, that comprises a non-zero transform coefficient is outside of a lowest frequency region of the second transform block, wherein the second plurality of coefficient groups each comprise a plurality of transform coefficients;
determine to code a second syntax element indicative of the MTS for the second transform block based at least in part on the determination of that no coefficient group is outside of the lowest frequency region of the second transform block; and
code the video data based at least in part on the determination to code the second syntax element indicative of the MTS for the second transform block.

14. The device of claim 13, wherein to determine that no coefficient group that comprises a non-zero coefficient group is outside of the lowest frequency region of the second transform block, the processor is further configured to:
determine, from the plurality of coefficient groups, of the second transform block, one or more coefficient groups for which a coded sub-block flag is set for each of the one or more coefficient groups;
determine that a position of each of the one or more coefficient groups is not greater than 3 in both an x-axis and a y-axis; and
in response to determining that the position of each of the one or more coefficient groups is not greater than 3 in both the x-axis and the y-axis, determine, for the second transform block of the video data, that no coefficient group, of the second plurality of coefficient groups of the second transform block, that comprises a non-zero transform coefficient is outside of a lowest frequency region of the second transform block.

15. The device of claim 11, wherein the lowest frequency region of the transform block comprises an upper-left region of the transform block.

16. The device of claim 15, wherein:
the transform block comprises a 32×32 block;
the upper-left region of the transform block comprises an upper-left 16×16 region of the 32×32 block; and
each of the plurality of coefficient groups comprises a 4×4 block of coefficients associated with the transform block.

17. The device of claim 11, wherein:
the syntax element indicative of the multiple transform selection for the transform block is indicative of a MTS index that specifies a separable transform for the transform block.

18. The device of claim 11, wherein:
the device comprises a video encoder to determine not to code the syntax element, the processor is configured to determine not to encode the syntax element; and
to code the video data based on the determination not to code the syntax element, the processor is configured to encode the video data without encoding the syntax element.

19. The device of claim 11, wherein:
the device comprises a video decoder;
to determine not to code the syntax element, the processor is configured to determine not to decode the syntax element; and
to code the video data based on the determination not to code the syntax element, the processor is configured to decode the video data without decoding the syntax element.

20. The device of claim 19, wherein to decode the video data, the processor is configured to:
in response to determining not to decode the syntax element, infer a value of the syntax element.

21. The device of claim 11, further comprising a display configured to display decoded video data.

22. The device of claim 11, wherein the device comprises one or more of a camera, a computer, a mobile device, a broadcast receiver device, or a set-top box.

23. The device of claim 11, wherein the device comprises at least one of:
an integrated circuit;
a microprocessor; or
a wireless communication device.

24. A device for coding data, the device comprising:
means for determining, for a transform block of video data, that at least one coefficient group, of the transform block, that comprises a non-zero transform coefficient is outside of a lowest frequency region of the transform block, wherein the at least one coefficient group is one of a plurality of coefficient groups that each comprise transform coefficients;
means for determining not to code a syntax element indicative of a multiple transform selection (MTS) for the transform block based at least in part on the determination of that the at least one coefficient group is outside of the lowest frequency region of the transform block; and
means for coding the video data based at least in part on the determination not to code the syntax element indicative of the multiple transform selection for the transform block.

25. The device of claim 24, wherein the means for determining that at least one coefficient group, of the transform block, that comprises a non-zero transform coefficient is outside of the lowest frequency region of the transform block further comprises:
means for determining, for a coefficient group of the plurality of coefficient groups comprising transform coefficients, that a coded sub-block flag for the coefficient group is set;
means for, in response to determining that the coded sub-block flag for the coefficient group is set, determining that a position of the coefficient group is greater than 3 in at least one of an x-axis or a y-axis; and
means for, in response to determining that the position of the coefficient group is greater than 3 in at least one of the x-axis or the y-axis, determining, for the transform block of the video data, that at least one coefficient group, of the transform block, that comprises a non-zero transform coefficient is outside of the lowest frequency region of the transform block.

26. The device of claim 24, further comprising:
means for determining, for a second transform block of video data, that no coefficient group, of a second plurality of coefficient groups of the second transform block, that comprises a non-zero transform coefficient is outside of a lowest frequency region of the second transform block, wherein the second plurality of coefficient groups each comprise a plurality of transform coefficients;
means for determining to code a second syntax element indicative of the MTS for the second transform block based at least in part on the determination of that no coefficient group is outside of the lowest frequency region of the second transform block; and
means for coding the video data based at least in part on the determination to code the second syntax element indicative of the MTS for the second transform block.

27. The device of claim 26, wherein the means for determining that no coefficient group that comprises a non-zero coefficient group is outside of the lowest frequency region of the second transform block comprises:
means for determining, from the plurality of coefficient groups, of the second transform block, one or more coefficient groups for which a coded sub-block flag is set for each of the one or more coefficient groups;
means for determining that a position of each of the one or more coefficient groups is not greater than 3 in both an x-axis and a y-axis; and
means for, in response to determining that the position of each of the one or more coefficient groups is not greater than 3 in both the x-axis and the y-axis, determining, for the second transform block of the video data, that no coefficient group, of the second plurality of coefficient groups of the second transform block, that comprises a non-zero transform coefficient is outside of a lowest frequency region of the second transform block.

28. The device of claim 24, wherein:
the means for determining not to code the syntax element comprises means for determining not to decode the syntax element; and
the means for coding the video data based on the determination not to code the syntax element comprises means for decoding the video data without decoding the syntax element.

29. The device of claim 28, wherein the means for decoding the video data further comprises:
means for, in response to determining not to decode the syntax element, inferring a value of the syntax element.

30. A computer-readable storage medium having stored thereon instructions that, when executed, cause one or more processors to:
determine, for a transform block of video data, that at least one coefficient group, of the transform block, that comprises a non-zero transform coefficient is outside of a lowest frequency region of the transform block, wherein the at least one coefficient group is one of a plurality of coefficient groups that each comprise transform coefficients;
determine not to code a syntax element indicative of a multiple transform selection (MTS) for the transform block based at least in part on the determination of that the at least one coefficient group is outside of the lowest frequency region of the transform block; and
code the video data based at least in part on the determination not to code the syntax element indicative of the multiple transform selection for the transform block.
